(19) United States
(12) Patent Application Publication
(10) Pub. No.: US 2008/0261450 A1
(43) Pub. Date: Oct. 23, 2008

(54) PORTABLE AND RETRACTABLE FLASH DRIVE WITH OPTIONAL ROTARY DEPLOYING AND RETRACTING AND FINGERPRINT VERIFICATION CAPABILITY

(75) Inventors: David Nguyen, San Jose, CA (US); Jim Chin-Nan Ni, San Jose, CA (US); Charles Chung Lee, Cupertino, CA (US); Abraham Chih-Kang Ma, Fremont, CA (US); Ming-Shiang Shen, Taipei Hsien (TW)

Correspondence Address: LAW OFFICES OF IMAM, 111 N. MARKET STREET, SUITE 1010, SAN JOSE, CA, 95113, US

(73) Assignee: SUPER TALENT ELECTRONICS, INC., San Jose, CA (US)

(21) Appl. No.: 11/924,540

(22) Filed: Oct. 25, 2007

Related U.S. Application Data
(63) Continuation-in-part of application No. 09/478,720, filed on Jan. 6, 2000, now Pat. No. 7,257,714.
Application No. 09/478,720 is a continuation-in-part of application No. 09/366,976, filed on Aug. 4, 1999, now Pat. No. 6,547,130.
Application No. 09/366,976 is a continuation-in-part of application No. 11/309,594, filed on Aug. 28, 2006, now Pat. No. 7,383,362.
Application No. 11/309,594 is a continuation-in-part of application No. 10/707,277, filed on Dec. 2, 2003, now Pat. No. 7,103,684.
Application No. 10/707,277 is a continuation-in-part of application No. 11/257,575, filed on Oct. 24, 2005, now Pat. No. 7,249,978.

(51) Int. Cl. H01R 13/648; H01R 43/00

(52) U.S. Cl. 439/607; 29/854

(57) ABSTRACT

In one embodiment of the present invention a portable and retractable flash drive with optional rotary deploying and retracting and fingerprint verification capability is disclosed to include a cylinder assembly. The cylinder assembly has a connector situated on one end, and a fingerprint sensor situated the surface. The portable and retractable flash drive with optional rotary deploying and retracting and fingerprint verification capability further includes a rotary tube at least partially enclosing the cylinder assembly for deploying the connector. An end tube is rotatably attached to one of the two ends of the rotary tube, and an end cap is attached to the other of the two ends of the rotary tube. The rotary tube is rotated relative to the end tube to slide the cylinder assembly back and forth inside the rotary tube to extend and retract the connector.

### CROSS REFERENCE TO RELATED APPLICATIONS

This application is a continuation in part (CIP) of co-pending U.S. patent application Ser. No. 09/478,720, entitled “Electronic Data Storage Medium with Fingerprint Verification Capability”, filed Jan. 6, 2000, which claims CIP benefit to U.S. patent application Ser. No. 09/366,976, entitled “Integrated Circuit Card with Fingerprint Verification Capability”, filed Aug. 4, 1999, U.S. patent application No. 9/366,976, now issued as U.S. Pat. No. 6,547,130.

This application is further a CIP of a co-pending U.S. patent application Ser. No. 11/309,594, entitled “Single-Chip Multi-Media Card/Secure Digital (MMC/SD) Controller Reading Power-On Boot Code from integrated Flash Memory for User Storage”, filed on Aug. 28, 2006, which is a CIP of U.S. patent application Ser. No. 10/707,277, entitled “Single-Chip USB Controller Reading Power-On Boot Code from Integrated Flash Memory For User Storage”, filed on Dec. 2, 2003. This application is a CIP of U.S. patent application Ser. No. 11/257,575 entitled “Reduced-Length, Low profile USB Device and Card-Like Carrier” and filed on Oct. 24, 2005. This application relates to U.S. Pat. No. 7,004,780, filed May 13, 2004, and entitled “Portable Computer Peripheral Apparatus with Retractable Plug Connector”, which is incorporated herein by reference as though set in full

### BACKGROUND OF THE INVENTION

1. Field of the Invention

The present invention relates generally to the field of portable flash drives and particularly to portable and retractable flash drives with optional rotary deploying and retracting and fingerprint verification capability and methods for manufacturing thereof.

2. Description of the Prior Art

As computers have gained enormous popularity in recent decades, so has the need for better and more efficient ways of storing memory. Notable among memory devices are the portable ones that may be carried around by the user to access computers at different locations. This is particularly common in the case of personal computers (PC) where the need often arises to transfer data from one PC to another. Examples of portable memory devices include nonvolatile memory devices such as a universal serial bus (USB) flash drive that is removably connectible to a computer.

Universal serial bus (USB) flash drives are available in various shapes and forms. The USB flash drive needs a USB connector to be coupled to a USB port of a host device such as a PC. The USB flash drive generally has a metal casing and a cover which is screwed in or otherwise attached to the casing. To access the USB connector the user needs to open the metal cover and put it back on the casing after finishing the work with the USB flash drive. The shape of the casing and cover may be in the form of a pen or some other configuration.

However, use of the metallic parts such as the casing and the cover generally results in a heavy USB flash drive, which is not very convenient to carry. The dimensions of the casing and cover are often large resulting in a long USB flash drive, which is another impediment to easy carriage of the unit. In addition, once the cover is removed, it may be lost or forgotten and not be replaced.

It is therefore desirable to design and develop a USB flash drive with a relatively short and compact configuration that is light and may therefore be easily carried around by the user. In particular, packaging style and shape of the portable USB flash drive maybe improved to generate additional interest and enthusiasm in using the device. In addition, the desired USB flash drive should not incur substantial cost of manufacturing but should rather improve the manufacturing and assembly process over the existing USB flash drives with metallic components.

Another consideration is protection of sensitive materials stored in a portable, removable memory drive. Specifically, it is not uncommon for a user of such a drive to store thereon sensitive or private information. If the drive is lost, misplaced, or stolen, it is often desirable to have a mechanism to prevent, or at least impede, unauthorized users from accessing data stored thereon.

In light of the foregoing, an improved USB flash drive is needed.

### SUMMARY OF THE INVENTION

Briefly, an embodiment of the present invention includes a portable and retractable flash drive with optional rotary deploying and retracting and fingerprint verification capability includes a cylinder assembly. The cylinder assembly has a connector situated on one end of the cylinder assembly, and a fingerprint sensor, the fingerprint sensor is disposed on a surface of the cylinder assembly. The portable and retractable flash drive with optional rotary deploying and retracting and fingerprint verification capability further includes a rotary tube having two ends at least partially enclosing the cylinder assembly for deploying the connector. An end tube is rotatably attached to one of the two ends of the rotary tube, and an end cap is attached to the other of the two ends of the rotary tube. The rotary tube is capable of being rotated relative to the end tube to slide the cylinder assembly back and forth inside the rotary tube to extend and retract the connector.

In an exemplary application, the connector is used to couple the portable and retractable flash drive with optional rotary deploying and retracting and fingerprint verification capability to a host device. The fingerprint sensor scans fingerprints of a user of the portable and retractable flash drive with optional rotary deploying and retracting and fingerprint verification capability, and allows access to data stored on the portable and retractable flash drive with optional rotary deploying and retracting and fingerprint verification capability.

The foregoing and other objects, features and advantages of the present invention will be apparent from the following detailed description of the preferred embodiment of the present inventions which make reference to several figures of the drawing.

### IN THE DRAWINGS

FIG. 1(a) shows an angular side view of a portable and retractable flash drive with optional rotary deploying and retracting and fingerprint verification capability 10 to include an end tube 14, rotary tube 16, a universal serial bus (USB) connector 12, an end cap 17, a rotary tube opening 800, a finger print scan pad 810, and a fingerprint sensor 820, in accordance with an embodiment of the present invention.

FIG. 1(b) shows an angular side view of the portable and retractable flash drive with optional rotary deploying and retracting and fingerprint verification capability 10.

FIG. 2 shows an exploded top view of the portable and retractable flash drive with optional rotary deploying and retracting and fingerprint verification capability 10 to include an end tube 14, a PCB holder 24, a PCB assembly 20, a PCB cover 26, a rotary tube 16, and an end cap 17 in accordance with an embodiment of the present invention.

FIG. 3 shows a perspective front view 31 of the end tube 14 and a perspective back view 32 of the end tube 14.

FIG. 4 shows an angular side view 33 of the rotary tube 16 and an angular side see-through view 34 of the rotary tube 16 in accordance with an embodiment of the present invention.

FIG. 5 shows an inside view 35 of the PCB holder 24 and an outside view 36 of the PCB holder 24.

FIG. 6 shows an inside view 37 of the PCB cover 26 and an outside view 38 of the PCB cover 26 in accordance with one embodiment of the present invention.

FIG. 7 shows a top angle view with further details of the PCB assembly 20 in accordance with one embodiment of the present invention.

FIG. 8 shows an angular side view of the end cap 17 in accordance with an embodiment of the present invention.

FIGS. 9-12 show steps used to manufacture the portable and retractable flash drive with optional rotary deploying and retracting and fingerprint verification capability 10, in accordance with a method of the present invention.

FIG. 9 shows the lower cylinder assembly 68 formed by joining of the PCB assembly 20 and the PCB holder 24 as a step used in the manufacturing process of the portable and retractable flash drive with optional rotary deploying and retracting and fingerprint verification capability 10 in accordance with a method of the present invention.

FIG. 10 shows the cylinder assembly 70 formed by joining of the lower cylinder assembly 68 with the PCB cover 26.

FIG. 11 shows the rotation mechanism assembly 90 formed by joining of the cylinder assembly 70 with the rotary tube 16 as a step in the manufacturing process of the portable and retractable flash drive with optional rotary deploying and retracting and fingerprint verification capability 10 in accordance with a method of the present invention.

FIG. 12 shows the portable and retractable flash drive with optional rotary deploying and retracting and fingerprint verification capability 10 formed by joining of the rotation mechanism assembly 90 with the end tube 14 and end cap 17.

FIG. 13 shows a see-through view of the portable and retractable flash drive with optional rotary deploying and retracting and fingerprint verification capability 10 in the deployed position.

FIG. 14 shows a see-through view of the portable and retractable flash drive with optional rotary deploying and retracting and fingerprint verification capability 10 in the retracted position.

FIG. 15 shows an exploded view of a different embodiment of a portable and retractable flash drive with optional rotary deploying and retracting and fingerprint verification capability 11 to include an end tube 14, a rotary tube 16, a PCB cover 110, a PCB support tray 48, a PCB assembly 49, and an end cap 17.

FIG. 16 shows a PCB support tray 48.

FIG. 17(a) shows the molding structure 45 to include a plastic PCB holder 47 and a metal case 46 according to an embodiment of the present invention.

FIG. 17(b) shows the molding structure 45 to comprise of the metal case 46 and the plastic USB holder 47, joined together, in accordance with one embodiment of the present invention.

FIG. 18 shows an inside view 111 and an outside view 112 of a PCB cover 110 in accordance with an embodiment of the present invention.

FIG. 19 shows a top view 118 and bottom view 119 of the PCB assembly 49 according to an embodiment of the present invention.

FIGS. 20-23 show steps used to manufacture the cylinder assembly 125, in accordance with a method of the present invention.

FIG. 20 shows the PCB/USB holding structure 123 formed by placing the PCB support tray 48 into the metal case 46 as a step used to manufacture the portable and retractable flash drive with optional rotary deploying and retracting and fingerprint verification capability 11 in accordance with a method of the present invention.

FIG. 21 shows the PCB/USB semi-cylinder 124 formed by joining the PCB assembly 49 with the PCB/USB holding structure 123 as a step used to manufacture the flash drive 11 in accordance with a method of the present invention.

FIG. 22 shows the cylinder assembly 125 formed by joining the PCB/USB semi-cylinder 124 with the PCB cover 110 as a step used to manufacture the portable and retractable flash drive with optional rotary deploying and retracting and fingerprint verification capability 11 in accordance with a method of the present invention.

FIG. 23 shows the assembled cylinder assembly 125 to include a USB connector 127, itself comprised of the metal case 46, the PCB support tray 48, and the contact fingers 13.

FIG. 24 shows a portable and retractable flash drive with optional rotary deploying and retracting and fingerprint verification capability 4 to comprise an end tube 14, a PCB support tray 48, a molding structure 150 itself comprising a metal case 46 and a plastic PCB holder 151, a PCB assembly 152, a PCB cover 170, a rotary tube 154, and an end cap 155 all in accordance with a different embodiment of the present invention.

FIG. 25 shows the molding structure 150 comprised of a metal case 46 and a PCB holder 151.

FIG. 26 shows an angular top view 171 and an angular bottom view 170 of the PCB cover 170.

FIG. 27 shows a top view and a bottom view of the PCB assembly 152 to comprise a printed circuit board (PCB) 169, a plurality of contact fingers 182, a front portion 184, a back portion 186, two front end notches 188, two memory ICs 2000, and one controller IC 1000 in accordance with an embodiment of the present invention.

FIG. 28 shows the molding structure 150 being joined with the PCB support tray 48 as a step in the manufacture of the portable and retractable flash drive with optional rotary deploying and retracting and fingerprint verification capability 4 in accordance with a method of the present invention

FIGS. 29-30 show steps used to manufacture the portable and retractable flash drive with optional rotary deploying and retracting and fingerprint verification capability 4, in accordance with a method of the present invention.

FIG. 31 shows the fully assembled connector assembly 192.

FIG. 32 shows a portable and retractable flash drive with optional rotary deploying and retracting and fingerprint verification capability 5 to comprise an end tube 14, a chip on board (COB) 200, a COB support plate 202, a metal case 210, an end plug 215, a rotary tube 154, and an end cap 240 in accordance with a different embodiment of the present invention.

FIG. 33 shows an angular top view and an angular bottom view of the COB support plate 202 to comprise a flat surface 203, a raised front end 205, a raised back end 208 and two front snap coupling tabs 207 situated on the raised front end 205, and four snap coupling back tabs 209 situated on the back side of the flat surface 203.

FIG. 34 shows an angular top view and an angular bottom view of the metal case 210 to comprise two snap coupling front slots 212, four snap coupling end slots 214, two USB standard top slots 213, and four snap coupling back slots 211, all in accordance with an embodiment of the present invention.

FIG. 35 shows an angular top view and an angular bottom view of the end plug 215 to include a front area 216, a back area 217, four snap coupling end tabs 218, two buttons 219, two COB end stops 220, and a rear stop 221, in accordance with an embodiment of the present application.

FIG. 36 shows a portable and retractable flash drive with optional rotary deploying and retracting and fingerprint verification capability 6 to comprise a housing chamber 302, a metal case 314, a COB support plate 318, a COB 322, a cover plate 326, an end cap 332, a connector pin 340, and a key ring 344 in accordance with a different embodiment of the present invention.

### DETAILED DESCRIPTION OF THE PREFERRED EMBODIMENT OF THE PRESENT INVENTIONS

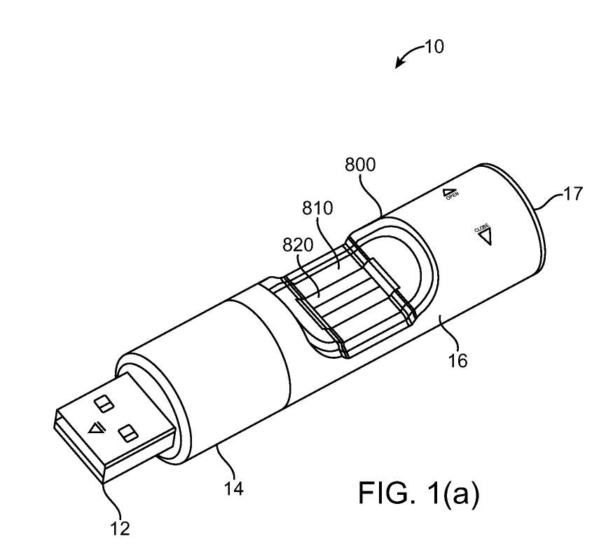

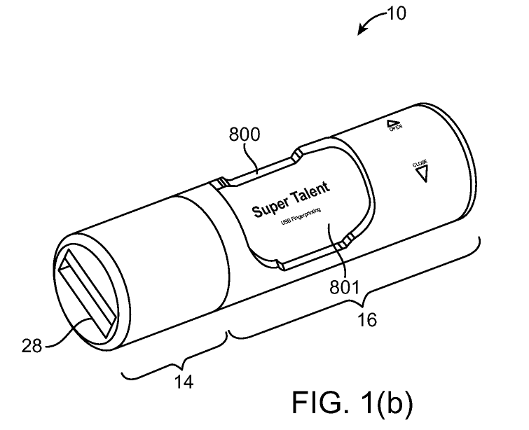

Referring now to FIG. 1(a), an angular side view of a portable and retractable flash drive with optional rotary deploying and retracting and fingerprint verification capability 10 is shown to include an end tube 14, rotary tube 16, a universal serial bus (USB) connector (or external host connector) 12, an end cap 17, a rotary tube opening 800, a finger print scan pad 810, and a fingerprint sensor 820, in accordance with an embodiment of the present invention. The portable and retractable flash drive with optional rotary deploying and retracting and fingerprint verification capability 10 is shown to be generally tubular or cylindrical in shape, generally similar to a lipstick. The end tube 14 is also substantially cylindrical in shape and the rotary tube 16 is generally a hollow cylinder in shape except that the substantially middle top portion thereof is a generally oval-shaped cut-out with a generally u-shaped cross section, forming the fingerprint sensor opening 815.

It should be noted that the shape of the fingerprint sensor opening 815 shown in FIG. 1(a) is only exemplary, and other shapes are also contemplated.

The rotary tube 16 is shown to be in contact with the end tube 14 at one end thereof. The USB connector (or external host connector) 12 is shown to protrude or extend out of the end tube 14. The fingerprint sensor 820 is shown situated substantially in the middle portion of the finger print scan pad 810. The finger print scan pad 810 is shown to have a generally u-shaped cross-section, matching the cut-out in the rotary tube 16. The end cap 17 is shown to be in contact with the rotary tube 16 at an end thereof that is opposite to the end to which the end tube 14 is connected.

In FIG. 1(a), the portable and retractable flash drive with optional rotary deploying and retracting and fingerprint verification capability 10 is shown to be in a deployed position with the USB connector 12 extending outwardly from the end tube 14 and with the finger print scan pad 810 seen through the fingerprint sensor opening 815.

The portable and retractable flash drive with optional rotary deploying and retracting and fingerprint verification capability 10 advantageously deploys and retracts the USB connector 12 into and out of the end tube 14. The USB connector 12 is used for removably connecting the portable and retractable flash drive with optional rotary deploying and retracting and fingerprint verification capability 10 to a host device, such as a personal computer (PC) when in the deployed position, in which case the USB connector 12 is coupled to a USB port of a host device.

The portable and retractable flash drive with optional rotary deploying and retracting and fingerprint verification capability 10 typically includes memory, such as non-volatile or flash memory, in the form of EEPROM or EPROM, in one or more semiconductors, used to store information in files. Examples of such files include word processing documents or photographs. When connected, information such as data and images may be transferred between the portable and retractable flash drive with optional rotary deploying and retracting and fingerprint verification capability 10 and the host device.

It should be noted that in one embodiment of the present invention, the USB connector 12 electrically connects with a host in compliance with the Universal Serial Bus (USB) standard, known and adopted by the industry at large. In other embodiments of the present invention, however, different interface standards, such as infrared, optical, wireless or other connection methods known by those in the art may be used.

The USB connector (or external host connector) 12 is deployed by extending it beyond the end tube 14, and retracted by withdrawing it into the end tube 14. The extension and retraction of the USB connector 12 is accomplished by turning the rotary tube 16 relative to the end tube 14. In one embodiment of the present invention, the USB connector 12 is deployed by turning the rotary tube 16 clockwise (CW) and counter clockwise (CCW), respectively, relative to the end tube 14. Thus, the portable and retractable flash drive with optional rotary deploying and retracting and fingerprint verification capability 10 has a lipstick shape which makes it advantageously portable and quite convenient to be carried.

The fingerprint sensor 820 is used for scanning the fingerprint of the user of the portable and retractable flash drive with optional rotary deploying and retracting and fingerprint verification capability 10. In one embodiment of the present invention, commercially available sensors are used as the fingerprint sensor 820. Users wishing to protect sensitive data stored on their portable and retractable flash drive with optional rotary deploying and retracting and fingerprint verification capability 10 scan their fingerprint on the fingerprint sensor 820. The scanned fingerprint, in digitized form, is stored in the portable and retractable flash drive with optional rotary deploying and retracting and fingerprint verification capability 10. Subsequently, any user wishing to access the sensitive data scans his or her fingerprint on the fingerprint sensor 820. Advantageously, only if the scanned fingerprint matches the stored fingerprint is the user able to retrieve or modify the sensitive data. The scanning functionality will be discussed in further detail below.

Referring now to FIG. 1(b) an angular side view of the portable and retractable flash drive with optional rotary deploying and retracting and fingerprint verification capability 10 is shown in retracted position to include a rotary tube 16 containing a rotary tube opening 800, through which is shown a “Super talent USB fingerprinting” logo 801 which is printed on the printed circuit board (PCB) holder 24. An USB connector opening 28 is shown to be situated substantially in the middle of one end of the end tube 14, in accordance with an embodiment of the present invention. The USB connector 12 (shown in FIG. 1(a)) retractably extends through the USB connector opening 28 when being deployed and slides into the USB connector opening 28 when being retracted.

The logo 801 may include brand, model, memory capacity, or functionality information, or any combination thereof. In other embodiments of the present invention, the logo 801 is an adhesive sticker placed upon the rotary tube 16. Besides giving users of the portable and retractable flash drive with optional rotary deploying and retracting and fingerprint verification capability 10 information about the device, the logo 801, when fully centered in the tube opening 800, advantageously indicates that the portable and retractable flash drive with optional rotary deploying and retracting and fingerprint verification capability 10 is fully retracted, as will be further discussed hereinbelow. In other embodiments, the portable and retractable flash drive with optional rotary deploying and retracting and fingerprint verification capability 10 does not have a logo 801 at all.

In the retracted position the USB connector 12 is situated inside the portable and retractable flash drive with optional rotary deploying and retracting and fingerprint verification capability 10. In the retracted position, the end tube 14 protects the USB connector 12 from damage. Furthermore, in the retracted position, the rotary tube opening 800 is obstructed by the PCB holder 24. Thus, the fingerprint scan pad 810 (shown in FIG. 1(a)) and the fingerprint sensor 820 (shown in FIG. 1(a)) are protected from the elements.

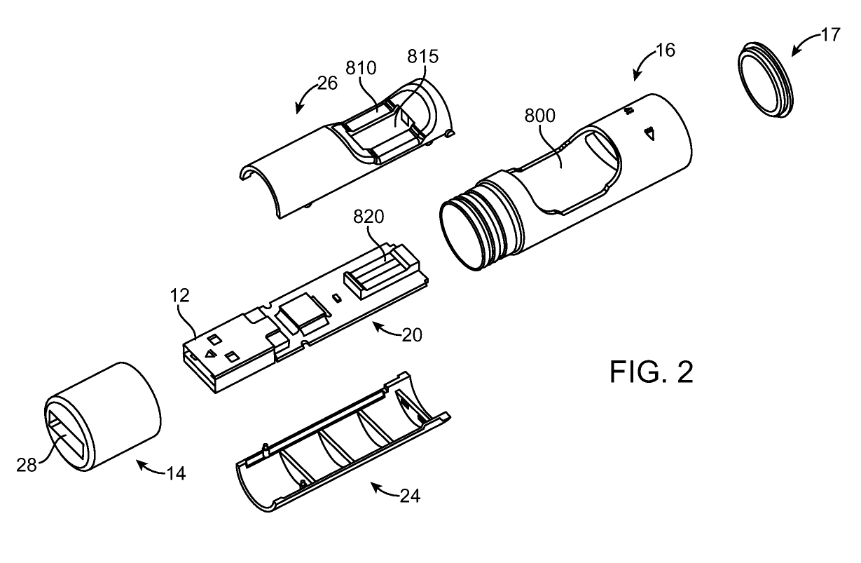

Referring now to FIG. 2, an exploded top view of the portable and retractable flash drive with optional rotary deploying and retracting and fingerprint verification capability 10 is shown to include an end tube 14, a PCB holder 24, a PCB assembly 20, a PCB cover 26, a rotary tube 16, and an end cap 17 in accordance with an embodiment of the present invention. The end tube 14 is shown to include a USB connector opening 28. The PCB assembly 20 is shown to include a USB connector 12, and a fingerprint sensor 820. The PCB cover 26 is shown to include a fingerprint scan pad 810 and a fingerprint sensor opening 815. The rotary tube 16 is shown to include a rotary tube opening 800.

In one embodiment of the present invention, the end tube 14, PCB holder 24, PCB cover 26, rotary tube 16, and end cap 17 are formed from plastic, although other materials may also be used. Some of the materials that may be used in the PCB assembly 20 are discussed in further detail hereinbelow.

In one embodiment of the present invention, the components depicted in FIG. 2, when fully assembled, comprise the portable and retractable flash drive with optional rotary deploying and retracting and fingerprint verification capability 10. The manner of assembly and functionality of the components are more fully discussed below.

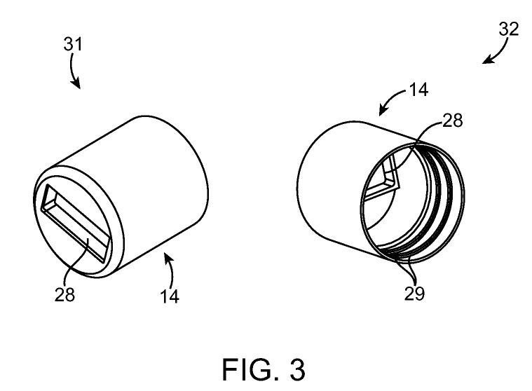

Referring now to FIG. 3, a perspective front view 31 of the end tube 14 and a perspective back view 32 of the end tube 14 are shown in accordance with an embodiment of the present invention. In view 32, the end tube 14 is shown to be generally cylindrical in shape, with a circular cross section. The end tube 14 is shown at one end to include the USB connector opening 28 and an opposite end, it is open. At its open end, the end tube 14 is shown to have two generally circular snap coupling ridges 29 located in the inner surface of the open end.

It should be noted that although the end tube 14 is shown here to contain two snap coupling ridges 29, in other embodiments of the present invention, the end tube 14 may contain one or a plurality of snap coupling ridges 29.

Although the connector opening 28 shown here to be in the dimensions of a USB connector and in accordance with USB standards, it should be noted that it is anticipated that in other embodiments of the present invention, the connector opening 28 can be shaped to be compatible with other connection standards.

In one embodiment of the present invention, the snap coupling ridges 29 are used to connect the end tube 14 to the rotary tube 16 (shown in FIGS. 1(a), 1(b), and 2), in a manner that allows the end tube 14 and rotary tube 16 to rotate relative to each other. As will be discussed in more detail later, rotation of the rotary tube 16 relative to the end tube 14 causes the portable and retractable flash drive with optional rotary deploying and retracting and fingerprint verification capability 10 to be deployed or retracted. In one embodiment of the present invention, when the portable and retractable flash drive with optional rotary deploying and retracting and fingerprint verification capability 10 is deployed, a USB connector 12 (shown in FIGS. 1(a) and 2) protrudes from the connector opening 28, allowing the USB connector 12 to plug into any compatible computing device to transfer data.

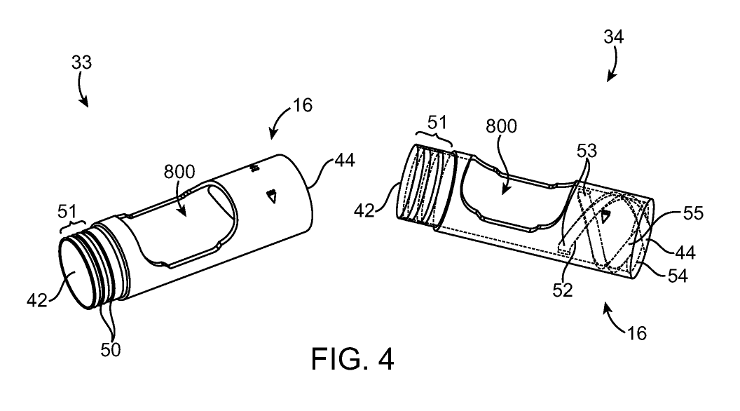

Referring now to FIG. 4, an angular side view 33 of the rotary tube 16 and an angular side see-through view 34 of the rotary tube 16 are shown in accordance with an embodiment of the present invention. The rotary tube 16 is shown to be generally a hollow cylindrical tube with a circular cross section, an open front end 42 and an open back end 44. A portion of the rotary tube close to the front end 42 is shown to have an outer diameter smaller than the outer diameter of the rest of the rotary tube 16, thus forming a front lip 51. Shown formed on the outer surface of, and circling the front lip 51 are one or more snap coupling grooves 50. The rotary tube 16 is shown to contain a rotary tube opening 800 cut out in its mid-section and on the outer surface on the front end 42. In the see-through view 34 the rotary tube 16 is shown to contain two spiral slots 52, each having two endings, a closed end 53 and an open end 55, all at the inner back end 44 side of the rotary tube 16. Also shown are internal threads 54 in the internal surface of the rotary tube 16 close to the end side 44. The spiral slots 52 are each shown to have a spiral shape and located within the inside of a back portion of the rotary tube 16 between the back end and the back edge of the rotary tube opening 800.

It should be noted that although two spiral slots 52 are shown, in other embodiments of the present invention, use of one or a plurality of spiral slots is anticipated.

As will be more fully discussed later, the snap coupling grooves 50 connect the rotary tube 16 to the end tube 14 (shown in FIGS. 1(a), 1(b), 2, and 3) in a manner that allows these two parts to rotate relative to each other. Furthermore, as will be discussed further hereinbelow, the spiral slots 52 enable the PCB assembly 20, encased in the PCB holder 24 and PCB cover 26 (all shown in FIG. 2) to jointly slide back and forth inside the rotary tube 16 as the rotary tube 16 is rotated relative to the end tube 14 (shown in FIGS. 1(a), 1(b), and 2). As the PCB assembly 20 slides back and forth, the USB connector 12 (shown in FIGS. 1(a) and 2) of the portable and retractable flash drive with optional rotary deploying and retracting and fingerprint verification capability 10 is deployed or retracted.

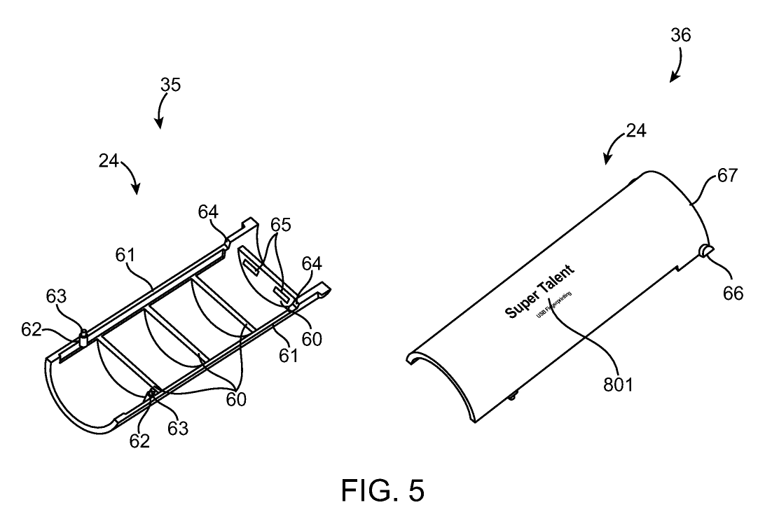

Referring now to FIG. 5 an inside view 35 of the PCB holder 24 and an outside view 36 of the PCB holder 24 are shown in accordance with one embodiment of the present invention. In the inside view 35 the PCB holder 24 is shown to be shaped generally as a hollow semi-cylinder with a semi-circular cross section, to include a plurality of ribs 60 across its width, with a plurality of snap coupling slots 65 in the rib 60 closest to one end. The PCB holder 24 is also shown to have two PCB mount surfaces 61 along a portion of the length of each lengthwise edge, and a PCB corner 64 at one end of each PCB mount surface 61. The PCB holder 24 is also shown to include a plurality of standoffs 62 along its lengthwise edges, with each standoff containing a pin 63 thereon. In the outside view 36 the PCB holder 24 is shown to include two outward pointing button-halves 66 on either side of one end, and a logo 801 printed in the mid section of the PCB holder 24. The semi-circular end surface of the PCB holder 24 situated on the same side as the button halves 66 is the end stop surface 67 of the PCB holder.

In one embodiment of the present invention, the PCB assembly 20 (shown in FIG. 2) rests upon the PCB holder 24 with the two long edges of the PCB assembly 20 resting upon the two PCB mount surfaces 61, and two corners of the PCB assembly 20 resting on the PCB corners 64, and the pins 63 protruding through the PCB assembly 20 and holding the assembly in place. The manner and functionality of joining the PCB assembly 20 and the PCB holder 24 is discussed in further detail hereinbelow.

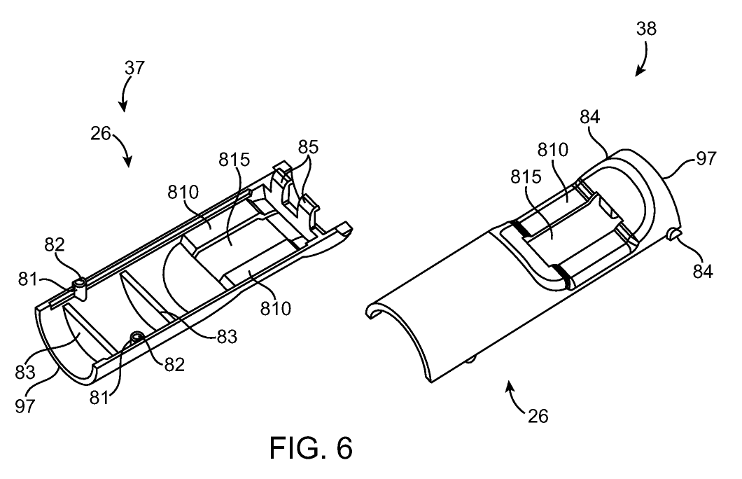

Referring now to FIG. 6, an inside view 37 of the PCB cover 26 and an outside view 38 of the PCB cover 26 are shown in accordance with one embodiment of the present invention. The PCB cover 26 is shown to include a plurality of ribs 83, two standoffs 81, two holes 82, a fingerprint sensor opening 815, a fingerprint scan pad 810, two snap coupling tabs 85, and two button-halves 84.

The PCB cover 26 is shown to be generally shaped as an hollow semi-cylinder with a generally semi-circular cross section. In the inside view 37 the PCB cover 26 is shown to include two standoffs 81, situated on the two lengthwise edges, close to one end. Each of the standoffs 81 is shown to contain therein a corresponding hole 82. The PCB cover 26 is also shown to include a plurality of semi-circular ribs 83 across the interior of its width. Each of the plurality of ribs 83 is shaped generally as a semi-circle, matching the cross-section of the PCB cover 26. Shown substantially toward the middle of the PCB cover 26 is the fingerprint scan pad 810, formed generally as an impression with a U-shaped cross-section and a flat center, into the side of the PCB cover 26 and containing a generally rectangular shaped fingerprint sensor opening 815 positioned generally in the center of the fingerprint scan pad 810.

The PCB cover 26 is also shown to have two snap coupling tabs 85 at the end of the PCB cover 26 that is opposite from the end housing the USB connector 12 (shown in FIGS. 1(a) and 2). The snap coupling tabs 85 are shown to be generally rectangular shaped, and formed vertical to the inner surface of the PCB cover 26.

In the outside view 38 of the PCB cover, the PCB cover 26 is shown to have two outward-pointing button-halves 84 situated at the exterior of the end thereof containing the snap coupling tabs 85. The semi-circular end surface of the PCB cover 26 situated at the same end where the button halves 84 are located is the end stop surface 97 of the PCB cover 26.

In one embodiment of the present invention, the PCB cover 26 is mounted on top of the PCB holder 24 (shown in FIGS. 2 and 5), with the PCB assembly 20 (shown in FIG. 2) situated between the two. Upon assembly of the PCB cover 26, the PCB holder 24, and the PCB assembly 20, the fingerprint sensor 820 (shown in FIGS. 1(a) and 2) mounted on the PCB assembly 20 protrudes through the fingerprint sensor opening 815 located on the PCB cover 26, and is generally flush with the fingerprint scan pad 810 on the PCB cover 26. Furthermore, the pins 63 situated on the standoffs 62 in the PCB holder 24 extend through the PCB assembly 20, and penetrate into the holes 82 situated in the standoffs 81 of the PCB cover 26, thus holding the PCB assembly 20 firmly in place.

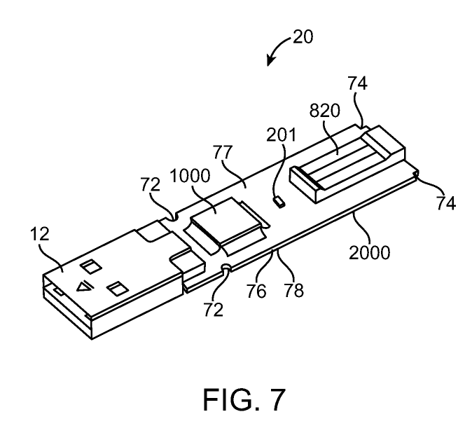

Referring now to FIG. 7, a top angle view with further details of the PCB assembly 20 is shown in accordance with one embodiment of the present invention. The PCB assembly 20 is shown to include a PCB substrate 76 comprising a top surface 77 and a bottom surface 78. The PCB assembly 20 is shown to further include a USB connector 12 situated on one end thereof and two slots 72 on either side of the two lengthwise edges of the PCB substrate 76 generally close to the USB connector 12. The PCB assembly 20 is shown to further include two cut-outs 74 at the two corners on the end of the PCB substrate 76 opposite to the end upon which the USB connector 12 is situated. Also shown are a controller integrated circuit (IC) 1000 and a fingerprint sensor 820, both mounted on the top surface 77 of the PCB substrate 76, and a memory IC 2000 mounted on the bottom surface 78 of the PCB substrate 76. Furthermore, shown situated between the controller IC 1000 and the fingerprint sensor 820 is a light emitting diode (LED) 201.

In assembling the PCB assembly 20, the substrate 76 is formed, whereupon the controller IC 1000, the memory IC 2000, the fingerprint sensor 820, and the LED 201 are mounted onto the substrate 76. In one embodiment of the present invention, the controller IC 1000, the memory IC 2000, the fingerprint sensor 820, and the LED 201 are mounted onto the substrate 76 using surface mount technology (SMT). In other embodiments of the present invention, other methods are used. After mounting the controller IC 1000, the memory IC 2000, the fingerprint sensor 820, and the LED 201, the connector 12 is connected to the PCB assembly 20. The materials used in forming the PCB substrates are commonly known to those well versed in the art of electronic assembly. The USB connector 12 is formed from conductive and non-conductive materials. The ICs 1000 and 2000 are formed from semi-conductors, and the materials and methods for their fabrication are commonly known to those well versed in the art of semiconductor fabrication. In one embodiment of the present invention, the fingerprint sensor 820 is simply purchased from commercially available products.

The PCB substrate 76 causes the USB connector 12 to be electrically coupled to the LED 201, fingerprint sensor 820, the controller IC 1000, and the memory IC 2000.

In an embodiment of the present invention, the memory IC 2000 stores data, and the controller IC 1000 reads and digitizes fingerprints scanned on the fingerprint sensor 820. In various embodiments of the present invention, the digitized fingerprint information (DFI) is compressed, encrypted, or both compressed and encrypted, by the controller IC 1000 to advantageously provide additional security against unauthorized use. The DFI, whether compressed, encrypted, or not, is stored. In various embodiments of the present invention, the DFI is stored on the controller IC 1000, or the memory IC 2000, or on an external device. In yet other embodiments of the present invention, the DFI is separated into sub-parts, and the sub-parts are stored at different location, thus advantageously providing added security against unauthorized use.

A user wishing to restrict data access to the flash drive runs their finger over the fingerprint scan pad 810 (shown in FIGS. 1(a), 2, and 6) whereby their fingerprint is read by the fingerprint sensor 820 and is stored, as discussed above. After at least one DFI is stored, the user can restrict access reading or writing to some, or all directories on the flash drive to specific users. Thereafter, a user wishing to store or retrieve data onto the restricted directories on the flash drive has to scan their finger on the fingerprint scan pad 810, whereupon their fingerprint is digitized, and compared against the stored DFI(s). Only if the user's digitized fingerprint matches the stored, authorized DFI(s) is the user allowed to store or retrieve data on restricted directories on the memory IC 2000.

The fingerprint verification functionality advantageously provides security against unauthorized access to the data stored on the portable and retractable flash drive with optional rotary deploying and retracting and fingerprint verification capability 10, even if the device is lost or stolen.

The LED 201 shows the status of the portable and retractable flash drive with optional rotary deploying and retracting and fingerprint verification capability 10. In other embodiments of the present invention (not shown) the PCB assembly 20 can have multiple LEDs with different colors, with, for example, one LED indicating “power on,” another indicating, for example, “data transfer in progress,” another indicating “fingerprint matched OK” and perhaps yet another indicating “fingerprint did not match.” In other embodiments of the present invention, additional status messages could be conveyed by blinking LEDs. For example, a steady green LED could indicate “power on” and a blinking green LED could indicate “data transfer in progress.” It should be noted that the LED status signals listed here are exemplary, and other signals are anticipated.

In other embodiments of the present invention, the PCB assembly 20 does not have an LED at all.

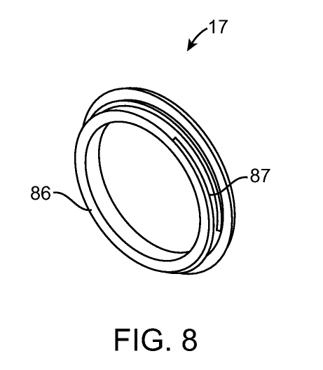

Referring now to FIG. 8 an angular side view of the end cap 17 is shown in accordance with an embodiment of the present invention.

The end cap 17 is shown to be generally shaped as a hollow circular ring, containing an end stop surface 86 and external threads 87. Situated along the inner circumference of the end cap 17 is shown a raised circular ledge. The top surface of the ledge is shown to form a flat end stop surface 86. On the outer surface of the ledge is shown deposed, a plurality of external threads 87.

It should be noted that in other embodiments of the present invention, the end cap can take other forms. For example, an end cap generally shaped as a complete circle, as opposed to a circular ring, may also be used.

The functions of the end cap 17, the end stop surface 86, and the external threads 87 will be discussed in further detail hereinbelow.

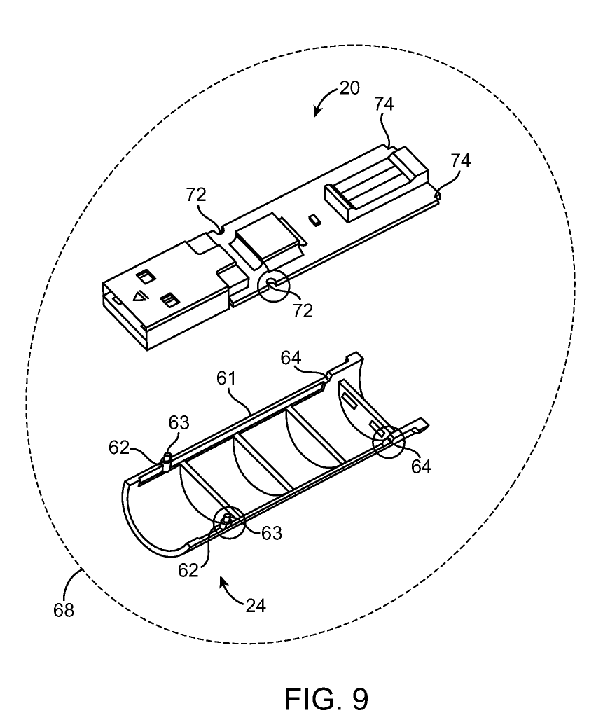

FIGS. 9-12 show steps used to manufacture the portable and retractable flash drive with optional rotary deploying and retracting and fingerprint verification capability 10, in accordance with a method of the present invention.

Referring now to FIG. 9, the lower cylinder assembly 68 is shown formed by joining of the PCB assembly 20 and the PCB holder 24 as a step used in the manufacturing process of the portable and retractable flash drive with optional rotary deploying and retracting and fingerprint verification capability 10 in accordance with a method of the present invention.

As shown in FIG. 9, the two sides along the length of the PCB assembly 20 are placed upon the two PCB mount surfaces 61 of the PCB holder 24. In doing so, the pins 63 on the standoffs 62 in the PCB holder 24 protrude through the two slots 72 in the PCB assembly. Furthermore, the two cut-outs 74 of the PCB assembly 20 fit into the two corners 64 of the PCB holder.

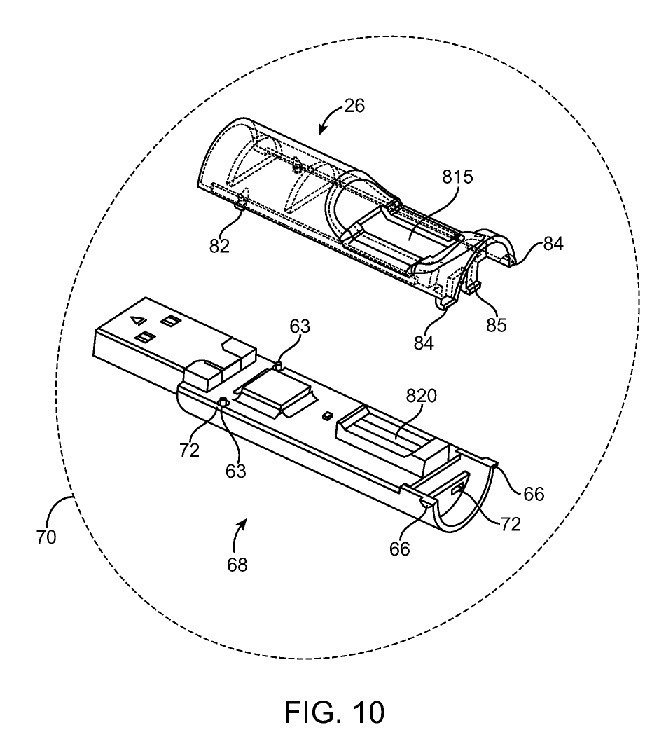

Referring now to FIG. 10, the cylinder assembly 70 is shown formed by joining of the lower cylinder assembly 68 with the PCB cover 26. As shown in FIG. 10, the tabs 85 of the PCB cover 26 are inserted into the slots 72 of the PCB holder 24. Furthermore, the pins 63 located on the PCB holder 24, having protruded through the slots 72 of the PCB assembly 20, are shown placed inside the holes 82 of the PCB cover 26, thus holding the lower cylinder assembly 68 firmly attached to the PCB cover 26. The fingerprint sensor 820 of the PCB assembly 20 which is part of the lower cylinder assembly 68 protrudes through the fingerprint sensor opening 815 of the PCB cover 26. The button-halves 66 of the PCB holder 24 which is part of the lower cylinder assembly 68 join the button-halves 84 of the PCB cover 26, to form two full buttons which enable the rotation and sliding functions, as will be discussed further hereinbelow. In one embodiment of the present invention, ultrasonic press is used in attaching the PCB cover 26 to the lower cylinder assembly 68.

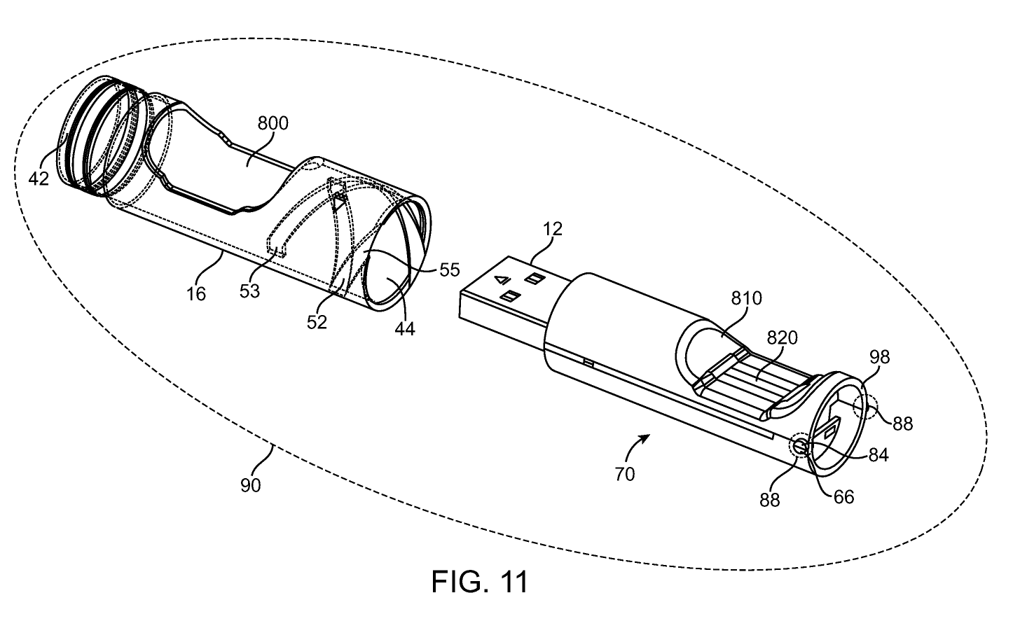

Referring now to FIG. 11, the rotation mechanism assembly 90 is shown formed by joining of the cylinder assembly 70 with the rotary tube 16 as a step in the manufacturing process of the portable and retractable flash drive with optional rotary deploying and retracting and fingerprint verification capability 10 in accordance with a method of the present invention.

As shown in FIG. 11, in joining the lower cylinder assembly 68 with the PCB cover 26, the button-halves 66 of the PCB holder 24 join with the button-halves 84 of the PCB cover 26, forming two buttons 88. The end stop surface 67 of the PCB holder 24 joins the end stop surface 97 of the PCB cover 26 to form the end stop surface 98 of the cylinder assembly 70. The outer diameter of the cylinder assembly 70 is less than the inner diameter of the rotary tube 16, allowing the cylinder assembly 70 to freely slide into the rotary tube 16. During the manufacturing process, the USB connector 12 of the cylinder assembly 70 is placed into open back end 44 of the rotary tube 16, and the cylinder assembly 70 is pushed into the rotary tube. In order to fully insert the cylinder assembly 70 into the rotary tube 16, the cylinder assembly 70 is rotated so that the two buttons 88 on the cylinder assembly 70 align with the two open ends 55 of the spiral slots 52. Thereafter, the cylinder assembly 70 rotatably travels inside the rotary tube 16. As the cylinder assembly 70 rotates, the buttons 88 slide in the spiral slots 52. The cylinder assembly 70 rotates forward, until the buttons 88 reach the closed end 53 of the spiral slots 52.

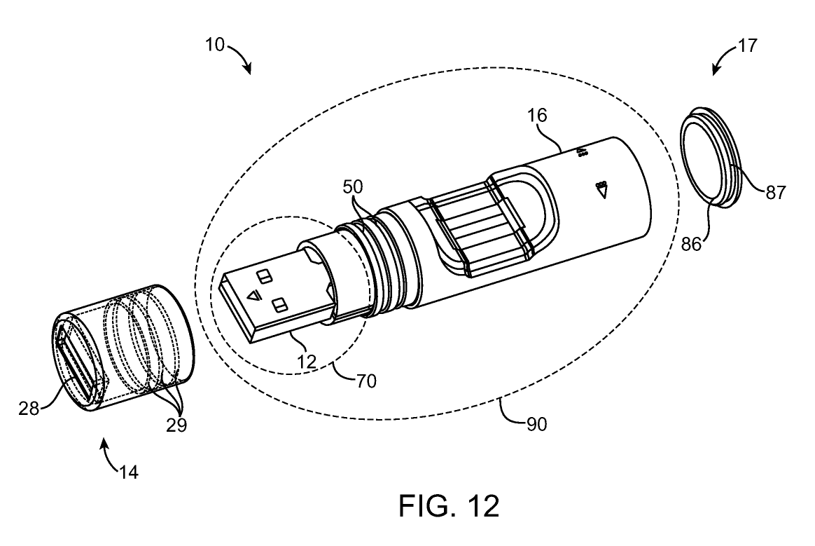

Referring now to FIG. 12, the portable and retractable flash drive with optional rotary deploying and retracting and fingerprint verification capability 10 is shown formed by joining of the rotation mechanism assembly 90 with the end tube 14 and end cap 17.

The rotation mechanism assembly 90 is shown to be comprised of the rotary tube 16, as well as the cylinder assembly 70. The USB connector 12 which is part of the cylinder assembly 70, is shown protruding out of the rotary tube 16.

As shown in FIG. 12, the end tube 14 is aligned with the end of the rotation mechanism assembly 90 containing the USB connector 12, such that the USB connector 12 protrudes, at least partly, through the USB connector opening 28 of the end tube 14. Thereafter, the end tube 14 is pressed onto the rotation mechanism assembly 90, such that the snap coupling ridges 29 of the end tube 14 snap onto the snap coupling grooves 50 of the rotary tube 16.

The assembly process may be performed using alignment fixture and press tool to hold the end tube 14 and rotation mechanism assembly 90 in proper positions to be pressed together, although other assembly processes may also be used. In one embodiment of the present invention, a user is able to remove the end tube 14 from the rotation mechanism assembly 90 if the user applies the same force as the press tool.

The end tube 14 is structured such that its inner diameter at the end where the snap coupling ridges 29 are located is larger than the outer diameter of the rotary tube 16, on the end where the snap coupling grooves 50 are located. The difference in the inner diameter of the end tube 14 and the outer diameter of the rotary tube 16 allows the end tube 14 to rotate relative to the rotary tube 16. Because the USB connector 12 protrudes at least partly through the USB connector opening 28 of the end tube 14, the USB connector 12, and the entire cylinder assembly 70 cannot rotate relative to the end tube 14. The fact that the cylinder assembly 70 and the end tube 14 cannot rotate relative to each other causes the cylinder assembly 70 to advantageously slide back and forth in the rotary tube 16, and the USB connector 12 to move in and out of the USB connector opening 28 of the end tube 14, as will be discussed in further detail hereinbelow.

Also shown in FIG. 12 is the end cap 17, as it attaches to the back end 44 of the rotary tube 16. The external threads 87 of the end cap 17 rotate into the internal threads 54 (shown in FIG. 4) substantially near the back end 44 (shown in FIG. 4) of the rotary tube 16 until the end cap 17 is firmly attached to the rotary tube 16. The end stop surface 86 (shown in FIG. 8) of the end cap 17 prevents the cylinder assembly 70 from falling out of the back end 44 of the rotary tube, as will be discussed further hereinbelow.

It should be noted that although in the embodiment of the present invention shown here, the end cap 17 is attached to the rotary tube 16 by engaging the external threads 87 of the end cap with the internal threads 54 of the rotary tube 16, in other embodiments of the present invention, it is anticipated that an end cap without external threads 87 can be used, wherein the end cap would attach to the rotary tube for example by use of ultrasonic bonding.

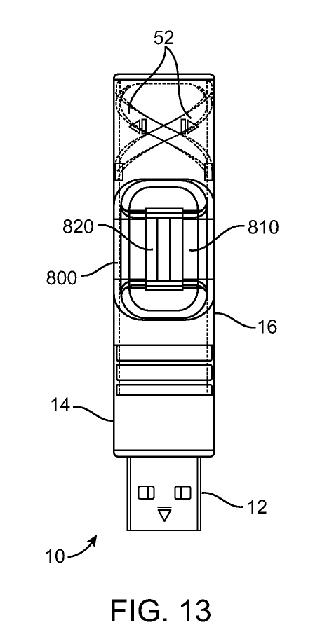

Referring now to FIG. 13, a see-through view of the portable and retractable flash drive with optional rotary deploying and retracting and fingerprint verification capability 10 is shown in the deployed position, with the USB connector 12 protruding out of the end tube 14, and the fingerprint sensor 820 and fingerprint pad 810 exposed through the rotary tube opening 800. Also shown in FIG. 13 are the spiral slots 52 inside the rotary tube 16.

In one embodiment of the present invention, as the rotary tube 16 is rotated clockwise relative to the end tube 14, the end tube 14 imparts torque upon the USB connector 12 and the entire cylinder assembly 70 (shown in FIGS. 10 and 11). As discussed above, the cylinder assembly 70 cannot rotate relative to the end tube 14, but can rotate relative to the rotary tube 16. As the cylinder assembly 70 rotates relative to the rotary tube 16, the buttons 88 (shown in FIG. 11) of the cylinder assembly 70 move forward in the spiral slots 52 of the rotary tube 16, causing the cylinder assembly 70 to slide out of the rotary tube 16, thus pushing the USB connector 12 out of the USB connector opening 28 of the end tube 14. The cylinder assembly 70 slides forward in the rotary tube 16, until the buttons 88 of the cylinder assembly 70 reach the closed ends of the spiral slots 53 (shown in FIG. 4), at which point the cylinder assembly 70 is stopped from further forward movement.

As the rotary tube 16 is rotated counter clockwise relative to the end tube 14, the end tube 14 imparts torque upon the USB connector 12 and the entire cylinder assembly 70. The cylinder assembly 70 rotates relative to the rotary tube 16, and the buttons 88 of the cylinder assembly 70 move backward in the spiral slots 52 of the rotary tube 16, causing the cylinder assembly 70 to slide into the rotary tube 16, thus pulling the USB connector 12 into the USB connector opening 28 of the end tube 14. The cylinder assembly 70 slides backward in the rotary tube 16, until the end stop surface 98 of the cylinder assembly 70 reach the end stop surface 86 of the end cap 17 (shown in FIG. 8), at which point the cylinder assembly 70 is stopped from further backward movement.

In other embodiments of the present invention, clockwise rotation of the rotary tube 16 relative to the end tube 14 causes the cylinder assembly 70 to move forward, and the counter clockwise rotation of the rotary 16 relative to the end tube 14 causes the cylinder assembly to move backward.

In one embodiment of the present invention, the spiral slots 52 extend approximately 12 millimeters lengthwise inside the rotary tube 16. The length of the spiral slots 52 enables the cylinder assembly 70 to slide approximately 12 millimeters inside the rotary tube 16. It should be noted that when measurements are provided, they are only exemplary, and other measurements are anticipated.

As discussed, the ability of the cylinder assembly 70 to slide in and out of the rotary tube 16 allows the USB connector 12 to extend out in the fully deployed position, or slide completely into the end tube 14 in the retracted position.

In one embodiment of the present invention, the spiral slots 52 spiral inside the rotary tube 16 in such a way as to cause the cylinder assembly 70 to rotate 180 degrees relative to the rotary tube 16. The ability of the cylinder assembly 70 to rotate 180 degrees relative to the rotary tube 16 allows the fingerprint sensor 820 (shown in FIGS. 1(a) and 7) and the fingerprint scan pad 810 (shown in FIGS. 1(a) and 6) to be exposed through the rotary tube opening 800 during the deployed position, or be advantageously rotated away and not be exposed to the elements in the retracted position. It should be noted that when angular degrees are provided, they are only exemplary, and larger or smaller angles are anticipated.

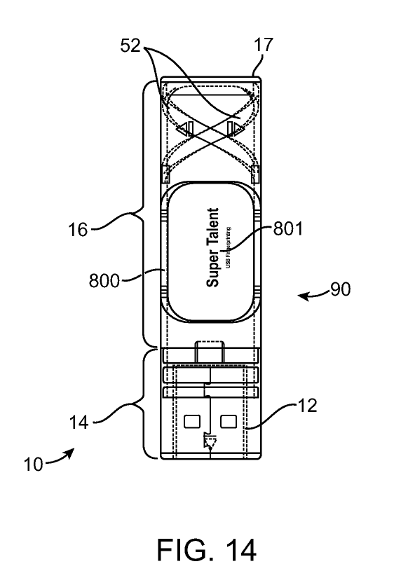

Referring now to FIG. 14, a see-through view of the portable and retractable flash drive with optional rotary deploying and retracting and fingerprint verification capability 10 is shown in the retracted position, with the USB connector 12 inside of the end tube 14, and the logo 801 exposed through tube opening 800, in accordance with an embodiment of the present invention.

When the portable and retractable flash drive with optional rotary deploying and retracting and fingerprint verification capability 10 is retracted, as is shown in FIG. 14, the buttons 88 (shown in FIG. 11) of the cylinder assembly 70 (shown in FIGS. 10 and 11) slide all the way back in the spiral slots 52 inside the rotary tube 16. The end stop surface 98 of the cylinder assembly 70 comes to rest against the end stop surface 86 of the end cap 17. The USB connector 12 is substantially flush with the exterior of the USB connector opening 28, and is thus advantageously protected from the elements.

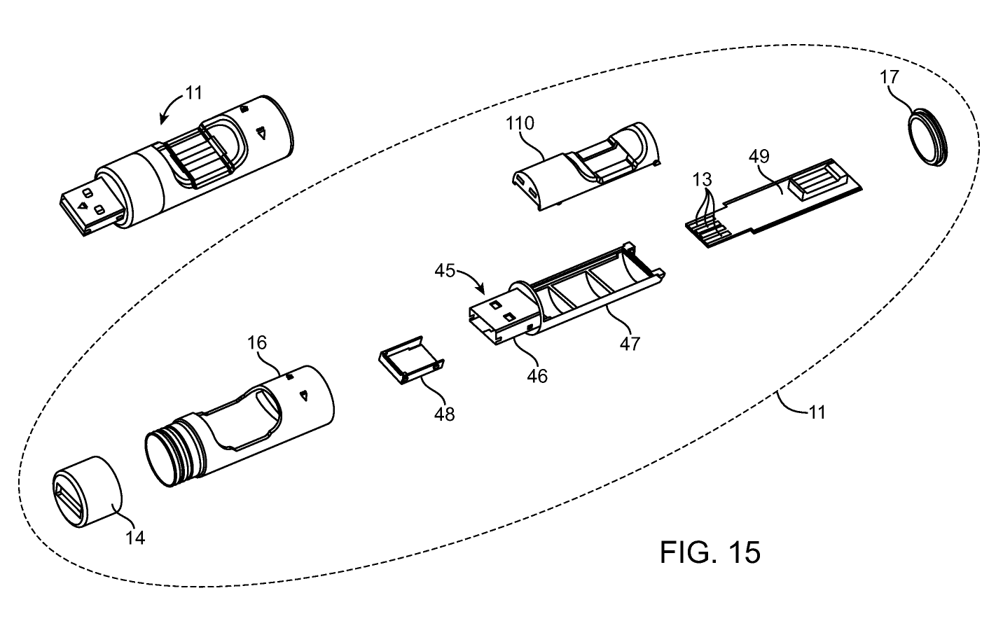

Referring now to FIG. 15, an exploded view and an angular view of a different embodiment of a portable and retractable flash drive with optional rotary deploying and retracting and fingerprint verification capability 11 is shown to include an end tube 14, a rotary tube 16, a PCB cover 110, a PCB support tray 48, a PCB assembly 49, and an end cap 17. Also shown is a molding structure 45, said molding structure to include a metal case 46 and a plastic PCB holder 47. Also shown is a PCB Assembly 49, said PCB assembly 49 to include a plurality of contact fingers 13. Finally, also shown are an end tube 14 and a rotary tube 16, all according to an embodiment of the present invention.

As will be discussed further hereinbelow, in the embodiment of the portable and retractable flash drive with optional rotary deploying and retracting and fingerprint verification capability 11 shown in FIG. 15 the PCB support 48, Molding structure 45, and the PCB assembly 49 jointly comprise a USB connector (or other external host device connector).

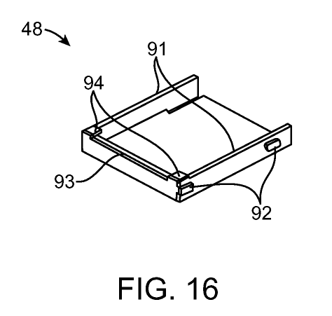

Referring now to FIG. 16, a PCB support tray 48 is shown to be generally square in shape, and include two raised sides 91 situated on two opposite ends, each raised side 91 containing on the outer edge thereof two snap coupling tabs 92, generally at the two ends of the raised side 91. The PCB support tray 48 is also shown to include a raised end 93. Also shown are two protrusion tabs 94 on the corners where the raised sides 91 meet the raised end 93, all according to one embodiment of the present invention.

It should be noted that although only two snap coupling tabs 92 are shown on each raised side, and only two protrusion tabs 94 are shown, other numbers are contemplated in other embodiments of the present invention.

The functionality of the PCB support tray 48 and the components thereof shall be explained in further detail hereinbelow.

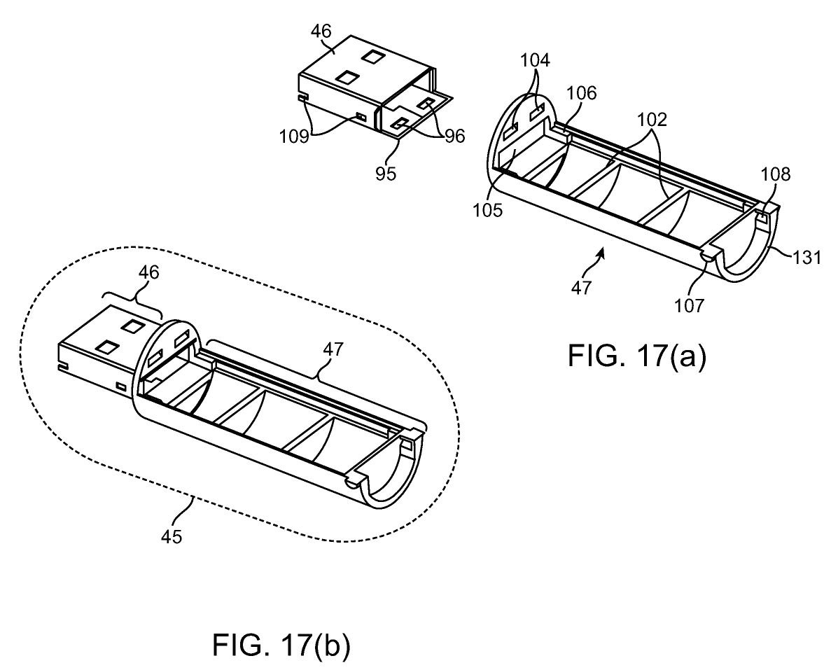

Referring now to FIG. 17(a), the molding structure 45 is shown to include a plastic PCB holder 47 and a metal case 46 according to an embodiment of the present invention.

The metal case 46 can be formed from any metals or alloys that allow malleability as well as electrical conductivity. Examples of metals that may be used in forming the metal case 46 include stainless steel 304 or steel alloy sheet metal with nickel plating. It should be noted that these metals are only exemplary, and it is anticipated that other metals may also be used. As shown, the metal case 46 is generally shaped as a three-dimensional rectangular cube with two narrow rectangular opposite sides, two wide rectangular opposite sides, and two rectangular open ends. In one embodiment of the present invention, the dimensions of the rectangular open end conform to the standard measurements of an USB connector, but in other embodiments dimensions conforming to other connectors may be used. Furthermore, as is shown in FIG. 17(a), the metal case 46 includes four snap coupling slots 109 along the two opposite and narrow sides thereof. The lower wide rectangular side is shown to be slightly longer than the other three sides, resulting in a connection tab 95 to protrude beyond the other three sides. Shown situated on the connection tab 95 are two tab slots 96.

It should be noted that although four snap coupling slots 109 and two tab slots 96 are shown, use of other numbers is contemplated in other embodiments.

The plastic PCB holder 47 is shown to be generally in the shape of an hollow half-cylinder with a semi-circular cross section and a plurality of ribs 102 across the width, a circular end 103 on one side, with the said circular end containing thereon a plurality of snap coupling slots 104 and a PCB-USB junction opening 105. The plastic USB holder 47 is further shown to contain, along the inner edge of each length-wide side, a longitudinal recess 106. The plastic USB holder 47 is further shown to include two outward-pointing button-halves 107 situated at the outer surface of the corner of end opposite to the end where the circular end 103 is located. The PCB holder 47 is shown to further include two snap coupling back slots 108 situated below the button-halves 107 but in the interior surface of the corner. The semi-circular end surface of the PCB holder 47 at the end where the button-halves 107 are located is the end stop surface 131 of the PCB holder 47.

In one embodiment of the present invention, the metal case 46 is formed first, then placed into an injection mold, whereupon plastic material is injected into the mold, forming plastic USB holder 47. The tab 95 and tab slot 96 of the metal case 46 help bond the metal case 46 to the USB holder 47. The resulting structure is the molding structure 45.

The functionality of the molding structure 45 and the components thereof will be discussed in further detail hereinbelow.

Referring now to FIG. 17(b) the molding structure 45 is shown to comprise of the metal case 46 and the plastic USB holder 47, joined together, in accordance with one embodiment of the present invention.

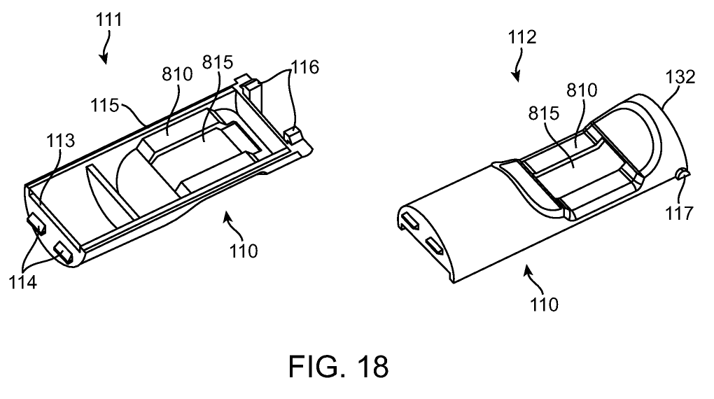

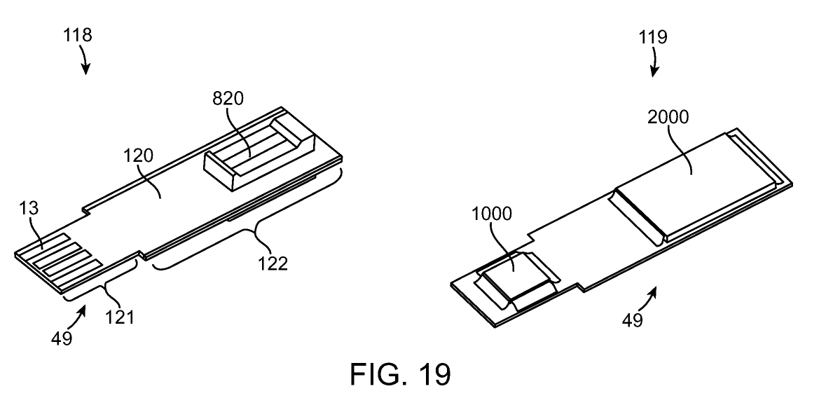

Referring now to FIG. 18, an inside view 111 and an outside view 112 of a PCB cover 110 are shown in accordance with an embodiment of the present invention. The inside view 111 shows the PCB cover 110 to be generally in the shape of an hollow semi cylinder, with a semi-circular cross-section, containing a fingerprint scan pad 820 in the general mid section. The fingerprint scan pad 820 is shown to be generally shaped as a flat impression, containing substantially in the middle thereof a fingerprint sensor opening 815, which is shown to be a generally a rectangular shaped opening. The PCB cover 110 is further shown to have a semi-circular front surface 113 containing thereon two snap coupling tabs 114. The semi-circular front surface 113 is shown to be shorter than the lengthwise edge of the PCB cover 110, resulting in two lengthwise protrusions 115 along the sides of the PCB cover 110. The PCB cover 110 is further shown to have two snap coupling back tabs 116 on the end opposite to the end where the semi-circular front surface 113 is situated. The outside view 112 of the PCB cover 110 shows the exterior of the PCB cover to have a fingerprint scan pad 810 in the mid section. Said fingerprint scan pad 810 is shown to contain therein a fingerprint sensor opening 815. Finally, the outside view 112 of the PCB cover 110 shows the PCB cover 110 to have two outward-pointing button-halves 117 situated on either side of the outer surface of the end where the snap coupling tabs 116 are situated. The semi-circular end surface of the PCB cover 110 on the end where the button halves 117 are located is the end stop surface 132 of the PCB cover 110.

As will be discussed further hereinbelow, the embodiment of the PCB cover 110 shown in FIG. 188 attaches to the PCB assembly 49 (shown in FIG. 15) and the molding structure 45 (shown in FIGS. 15 and 17(b)) to allow the rotating and retracting functionality of the portable and retractable flash drive with optional rotary deploying and retracting and fingerprint verification capability 11.

Referring now to FIG. 19, a top view 118 and bottom view 119 of the PCB assembly 49 is shown according to an embodiment of the present invention. Shown in the top view 118 is the PCB substrate 120, generally rectangular in shape and comprised of a front portion 121 and a back portion 122. The front portion is shown to be slightly narrower than the front portion. Situated on the front portion 121 is shown a plurality of contact fingers 13, and mounted on the back portion 122, is shown a fingerprint sensor 820. Shown in the bottom view 119 is the PCB substrate 120, attached to which is shown a controller IC 1000 and a memory IC 2000.

In one exemplary embodiment of the present invention, the contact fingers 13 are formed from copper. In one embodiment of the present invention the contact fingers 13, the front portion 121, and the metal case 46 comprise at least a part of a USB standard connector. However, it is anticipated that the contact fingers 13, the front portion 121, and the metal case 46 comprise a part of a connector conforming to a different connection standard. The PCB substrate 120 creates electrical connectivity between the contact fingers 13, the controller IC 1000, the memory IC 2000, and the fingerprint sensor 820.

As is discussed more fully above, the memory IC 2000 generally stores data, and the controller IC 1000 generally contains logic for operation of the flash drive 11. Furthermore, as is discussed more fully above, the fingerprint sensor 820 is used in scanning fingerprints of users for security purposes. A detailed discussion of the foregoing is avoided due to redundancy.

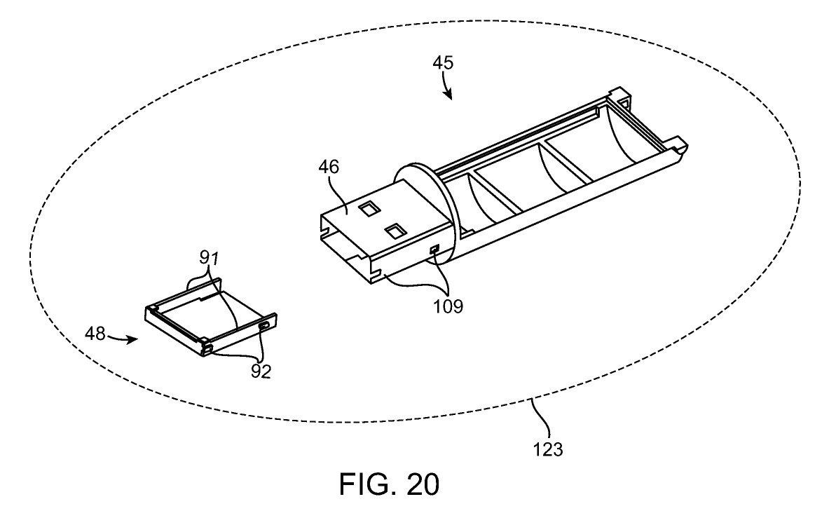

FIGS. 20-23 show steps used to manufacture the cylinder assembly 125, in accordance with a method of the present invention.

Referring now to FIG. 20, the PCB/USB holding structure 123 is shown formed by placing the PCB support tray 48 into the metal case 46 as a step used to manufacture the flash drive 11 in accordance with a method of the present invention.

In the step shown in FIG. 20, the PCB support tray 48, with its raised sides 91 and raised end 93 facing up, is inserted into the metal case 46. The snap coupling tabs 92 of the PCB support tray 48 snap into the snap coupling slots 109 of the metal case 46, firmly holding the PCB support tray 48 in place.

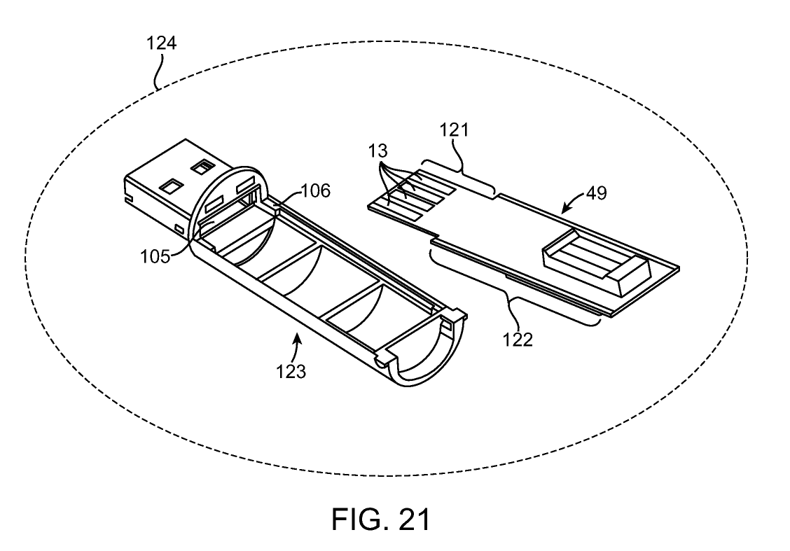

Referring now to FIG. 21, the PCB/USB semi-cylinder 124 is shown formed by joining the PCB assembly 49 with the PCB/USB holding structure 123 as a step used to manufacture the flash drive 11 in accordance with a method of the present invention.

As is shown in FIG. 21, the front portion 121 of the PCB assembly is placed through the PCB-USB junction opening 105 and the lengthwise edges of the back portion 122 of the PCB assembly 49 are placed on the longitudinal recesses 106 of the molding structure 123. The contact fingers 13 rest on the PCB support tab 48, which is installed inside the USB meal case 46, as discussed above. The front portion 121 of the PCB assembly is held in place by the protrusion tabs 94 of the PCB support tray 48, which is held firmly in place inside the USB connector 12.

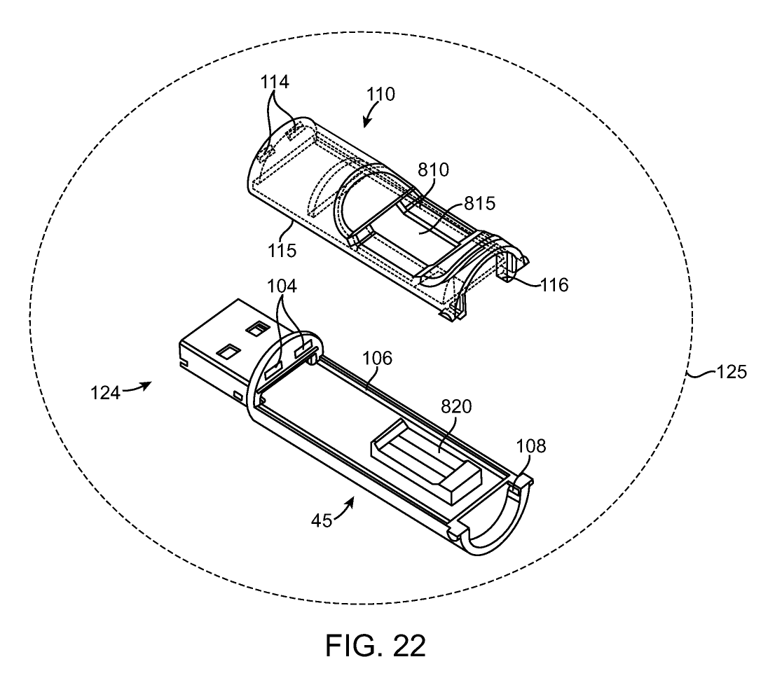

Referring now to FIG. 22, the cylinder assembly 125 is shown formed by joining the PCB/USB semi-cylinder 124 with the PCB cover 110 as a step used to manufacture the flash drive 11 in accordance with a method of the present invention.

In forming the cylinder assembly 125, the snap coupling tabs 114 of the PCB cover 110 snap into the front slots 104 of the molding structure 45. Furthermore, the lengthwise protrusions 115 of the PCB cover 110 are placed onto the recesses 106 of the molding structure 45. Finally, the back tabs 116 of the PCB cover 110 snap into the back slots 108 of the molding structure 108. After the cylinder assembly 125 is formed, the fingerprint sensor 820 of the PCB assembly 49 protrudes through the fingerprint sensor opening 815 of the PCB cover 110, and is substantially flush with the fingerprint scan pad 810 of the PCB cover 110.

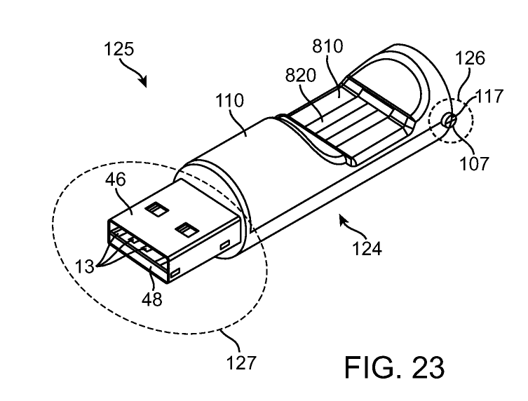

Referring now to FIG. 23, the assembled cylinder assembly 125 is shown to include a USB connector 127, itself comprised of the metal case 46, the PCB support tray 48, and the contact fingers 13. Shown formed on the cylinder assembly 125, on the side opposite to the USB connector 127, are two buttons 126, each comprised of a half button 117 from the PCB cover 110, and a half button 107 from the PC/USB semi-cylinder 124

The cylinder assembly 125, although assembled differently from and comprising slightly different components than the cylinder assembly 70 discussed hereinabove, functions identically thereto. Therefore, the final assembly steps are identical to those described more fully hereinabove, and shown in FIGS. 11 and 12. Likewise the rotating, retracting, protruding, and fingerprint verification functionalities of the embodiment of the portable and retractable flash drive with optional rotary deploying and retracting and fingerprint verification capability 11 shown in FIGS. 15 through 23 are all identical to that of those of the previous embodiment shown in FIGS. 1 through 22 and described more fully hereinabove. A detailed discussion of the foregoing is avoided due to redundancy.

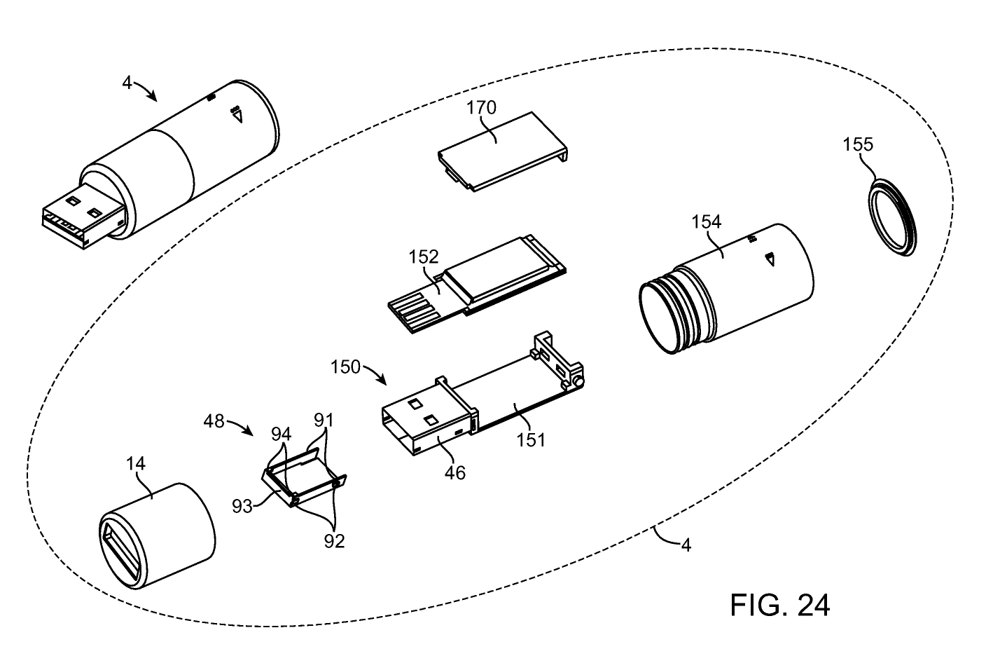

Referring now to FIG. 24, an exploded view and an angular view of a different embodiment of a portable and retractable flash drive with optional rotary deploying and retracting and fingerprint verification capability 4 is shown to comprise an end tube 14, a PCB support tray 48, a molding structure 150 itself comprising a metal case 46 and a plastic PCB holder 151, a PCB assembly 152, a PCB cover 170, a rotary tube 154, and an end cap 155 all in accordance with a different embodiment of the present invention.

The manner of assembly and functionalities of the flash drive 4 and each of the components thereof shown in FIG. 24 will be discussed in further detail hereinbelow.

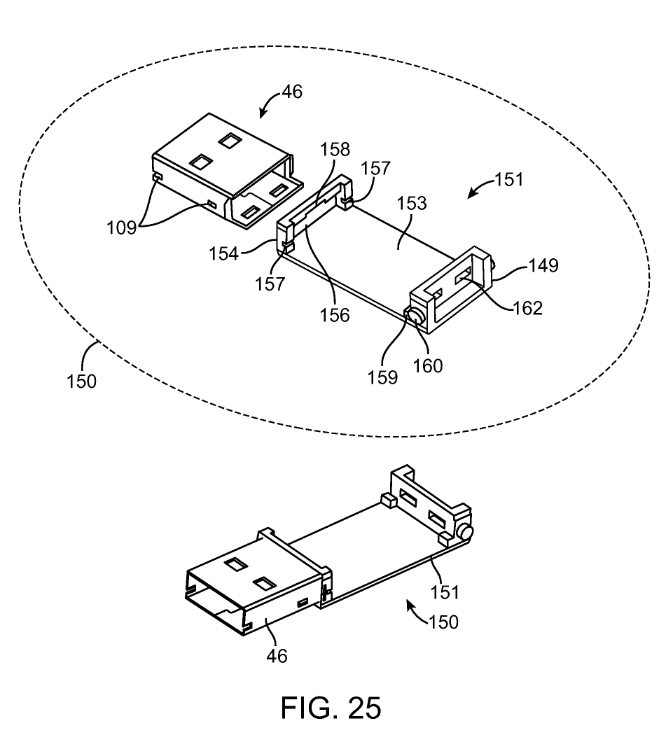

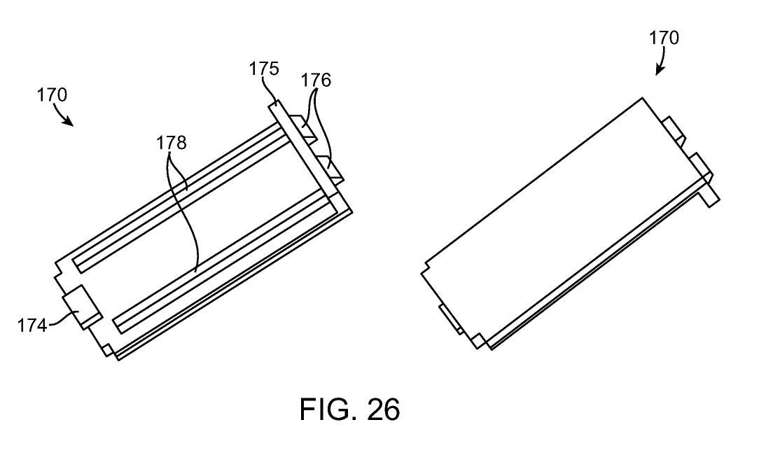

Referring now to FIG. 25, the molding structure 150 is shown comprised of a metal case 46 and a PCB holder 151. The PCB holder 151 is shown to comprise a rectangular flat surface 153, a plastic front fixture 154 perpendicularly situated on one end across the width of the rectangular flat surface 153, and a plastic rear area 149 perpendicularly situated across the other width of the rectangular flat surface 153. The front fixture 154 is shown to be generally shaped like a 3-sided rectangular frame, with a long edge and two short edges, surrounding a PCBA opening 156. Situated on the long edge of the front fixture 154 is shown a snap coupling cut-out 158 facing downward. Shown situated on the two short sides of the front fixture 154 are two snap coupling front slots 157 facing backward. The back fixture 155 is shown to be generally rectangularly shaped and comprise of two buttons 160 on either side, and two snap coupling back slots 162 on the rear. Two standoffs 159 shaped generally as raised areas are shown situated on either side of the line formed at the front side of the intersection of the back fixture 155 and the flat surface 153.

It should be noted that although two snap coupling front slots 157, two snap coupling back slots 162, and two buttons 106 are shown, these are exemplary only, and other numbers are contemplated.

In one embodiment of the present invention, in forming the molding structure 150 the metal case 46 and the PCB holder 151 are molded together.

The functionalities of the molding structure 150 and the components thereof will be discussed in further detail hereinbelow.

Referring now to FIG. 26, an angular top view 171 and angular bottom view 170 of the PCB cover 170 is shown. The PCB cover 170 is shown to be substantially rectangular in shape, with a protrusion tab 174 situated thereon approximately in the middle of one widthwise side thereof. The other widthwise side of the PCB cover 170 is shown to have a raised end 175 shown to be raised vertically along the width of the PCB cover 170, with two snap coupling back tabs 176 situated on the back side thereon. Also shown are two longitudinal protrusions 178 situated running lengthwise on the PCB cover 170, all in accordance with one embodiment of the present invention.

It should be noted that although one protrusion tab 174, two snap coupling back tabs 155, and two longitudinal protrusions 178 are shown, these numbers are exemplary, and other numbers are contemplated.

The functionalities of the PCB cover 170 and the components thereof will be discussed in further detail hereinbelow.

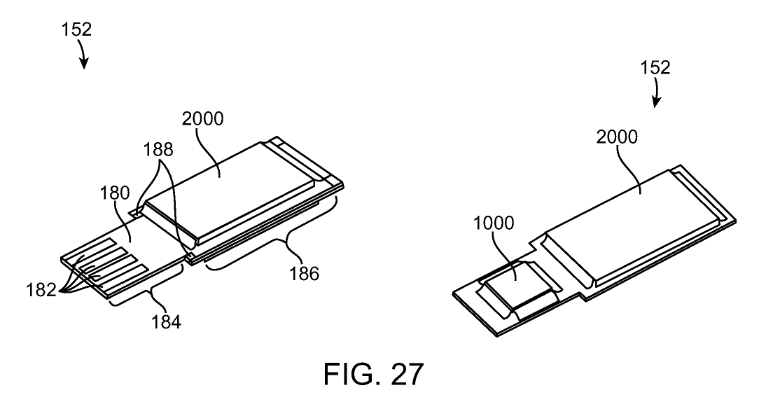

Referring now to FIG. 27, a top view and bottom view of the PCB assembly 152 is shown to comprise a printed circuit board (PCB) 169, a plurality of contact fingers 182, a front portion 184, a back portion 186, two front end notches 188, two memory ICs 2000, and one controller IC 1000 in accordance with an embodiment of the present invention.

The PCB 180 is shown to be generally rectangular in shape, with one half thereof comprising the front portion 184, and the other half comprising the back portion 186. The front portion 184 is shown slightly narrower than the back portion 186, resulting in two front end notches 188 where the front portion 184 meets the back portion 186. The contact fingers 182 are shown to be situated on the top side of the front portion 184 and at the edge thereof. Shown situated on the bottom side of the front portion 184 is the controller IC 1000. Shown situated on the top and bottom sides of the back portion are two memory ICs 2000.

The memory ICs 2000 store data, and the controller IC contains operational logic to direct data transferring between the host device and the memory IC 2000.

The functions of the PCB assembly 152 and the components thereof will be discussed in further detail hereinbelow.

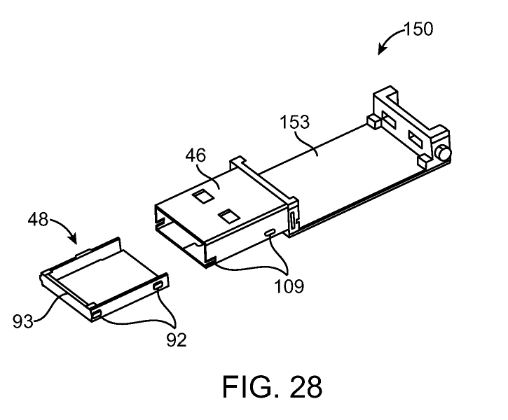

FIGS. 28-30 show steps used to manufacture the portable and retractable flash drive with optional rotary deploying and retracting and fingerprint verification capability 4, in accordance with a method of the present invention.

Referring now to FIG. 28, the molding structure 150 is shown being joined with the PCB support tray 48 as a step in the manufacture of the portable and retractable flash drive with optional rotary deploying and retracting and fingerprint verification capability 4 in accordance with a method of the present invention

As is shown in FIG. 28, the PCB support tray 28 is placed, with its raised sides facing up, and the raised end 93 facing out, into the opening of the USB meal case 46. The snap coupling tabs 92 fit into the snap coupling slots 109 of the metal case 46, thus holding the two parts firmly together.

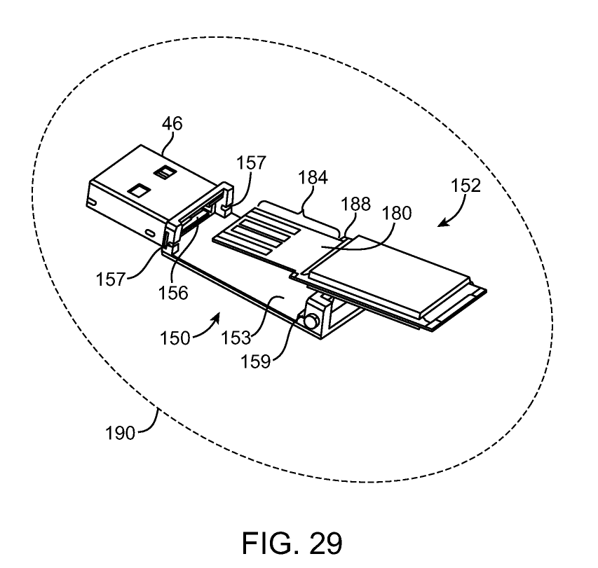

Referring now to FIG. 29, the PCB/USB lower assembly 190 is shown formed by joining the PCB assembly 152 with the molding structure 150, as a step in the manufacture of the portable and retractable flash drive with optional rotary deploying and retracting and fingerprint verification capability 4 in accordance with a method of the present invention. As is shown in FIG. 29, the front portion 184 of the PCB assembly 152 slides into the PCBA opening 156 of the metal case 46. Thus, the front end notches 188 of the PCB assembly 152 snap into the snap coupling front slots 157 of the molding structure 150, holding PCB assembly firmly in place. The back side of the PCB assembly 152 rests on the standoffs 159 of the molding structure 150. The standoffs 159 and the front slots 157 are both raised from the flat surface 153. In one embodiment of the present invention, the distance between the flat surface 153 and the top of the standoff 159 is the same as the distance between the bottom of the front slots 157 and the flat surface 153, and is more than the height of the memory IC 2000 (shown in FIG. 27) mounted on the bottom of the PCB 180. Thus, the bottom mounted memory IC 2000 fits in the space created between the PCB 180 and the flat surface 153.

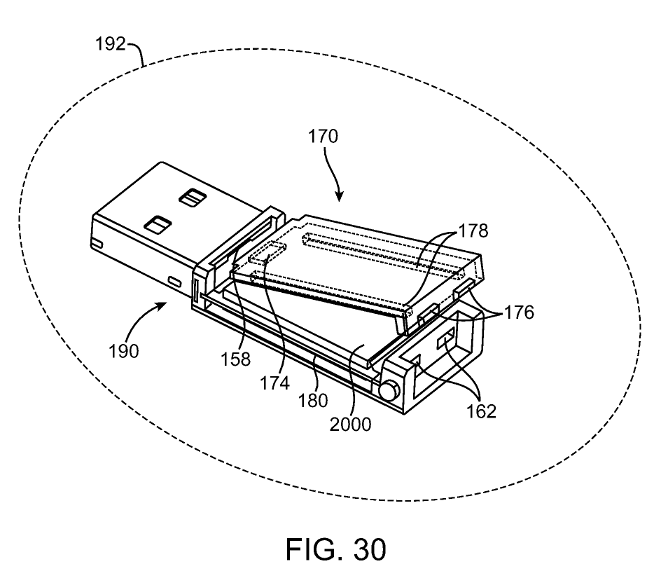

Referring now to FIG. 30, the connector assembly 192 is shown formed by joining the PCB/USB lower assembly 190 with the PCB cover 170 as a step in the manufacture of the portable and retractable flash drive with optional rotary deploying and retracting and fingerprint verification capability 4 in accordance with a method of the present invention

As is shown in FIG. 30, the protrusion tab 174 of the PCB cover 170 is inserted into the snap coupling cut-out 158 of the molding structure 150. Furthermore, the back tabs 176 of the PCB cover 170 are placed into the back slots 162 of the molding structure 150. Finally, the two longitudinal protrusions 178 of the PCB cover 170 rest on top of the memory IC 2000 situated on top of the PCB 180. Thus, the PCB cover 170 is held firmly attached to the PCB/USB lower assembly.

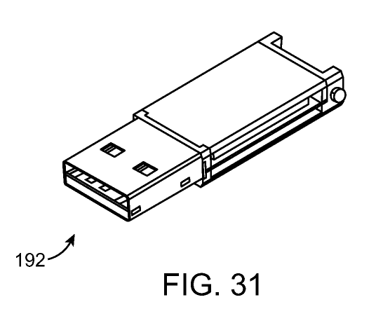

Referring now to FIG. 31, the fully assembled connector assembly 192 is shown.

The rotary tube 154 contains therein spiral slots similar to the spiral slots of the rotary tube 16, discussed hereinabove. The fully assembled connector assembly 192 is inserted into the rotary tube 154, with the buttons 160 aligned with, and inserted into, the spiral slots. The end tube 14 is snapped onto one side of the rotary tube, and the end cap 155 is screwed onto the other side.

As discussed above, rotating the rotary tube 154 relative to the end tube 14 causes the connector assembly 192 to slide back and forth inside the rotary tube, advantageously deploying and retracting the USB connector. A detailed discussion of the foregoing is avoided due to redundancy

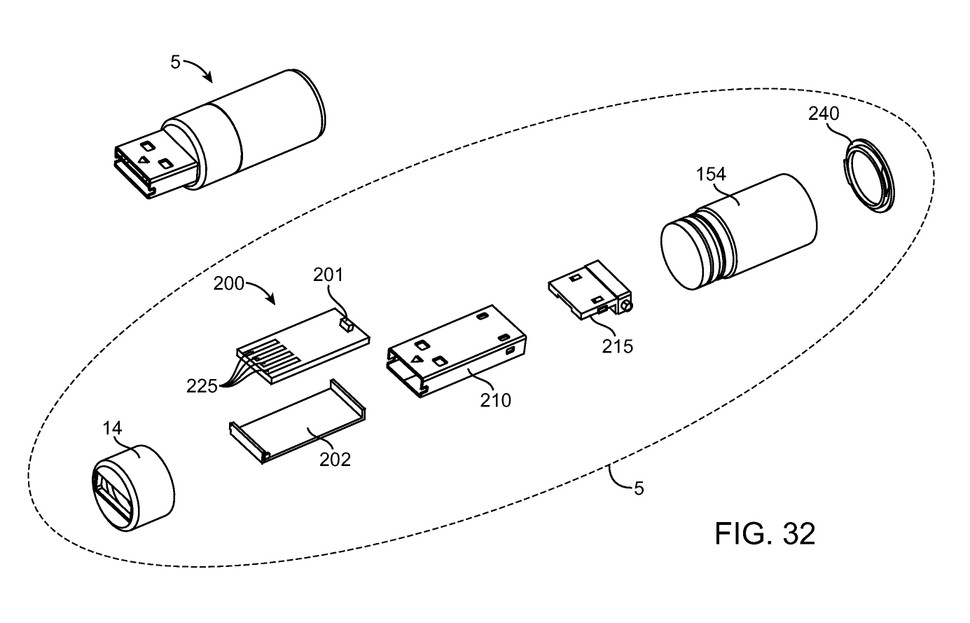

Referring now to FIG. 32, an exploded view and an angular view of a portable and retractable flash drive with optional rotary deploying and retracting and fingerprint verification capability 5 is shown to comprise an end tube 14, a chip on board (COB) 200, a COB support plate 202, a metal case 210, an end plug 215, a rotary tube 154, and an end cap 240 in accordance with a different embodiment of the present invention.

The COB 200 itself is shown to include a light emitting diode (LED) 201 and a plurality of contact fingers 225. The COB 200 contains memory, as well as logic circuitry as necessary to direct data transfer between the host device and the memory circuitry. In one embodiment of the present invention, the COB is manufactured by first fabricating a semiconductor IC or “chip”, then using tape automated bonding (TAB) process to place the chip on a PCB. After the chip's wires are attached to the PCB, a layer of epoxy or plastic covers the chip and the connections, resulting in a COB.

The LED shows the status of the portable and retractable flash drive with optional rotary deploying and retracting and fingerprint verification capability 5. In other embodiments of the present invention (not shown) the COB can have multiple LEDs, with, for example, one LED indicating “power on” and another indicating, for example, “data transfer in progress.” In other embodiments of the present invention, the COB does not have an LED at all. Additionally, it should be noted that whereas the COB 200 shown in FIG. 32 has 4 contact fingers 225 in conformance with USB standards, this is only exemplary, and a different number of contact fingers, conforming with other standards is contemplated.

The structure, interconnectivity, and function of these components will be discussed in further detail hereinbelow.

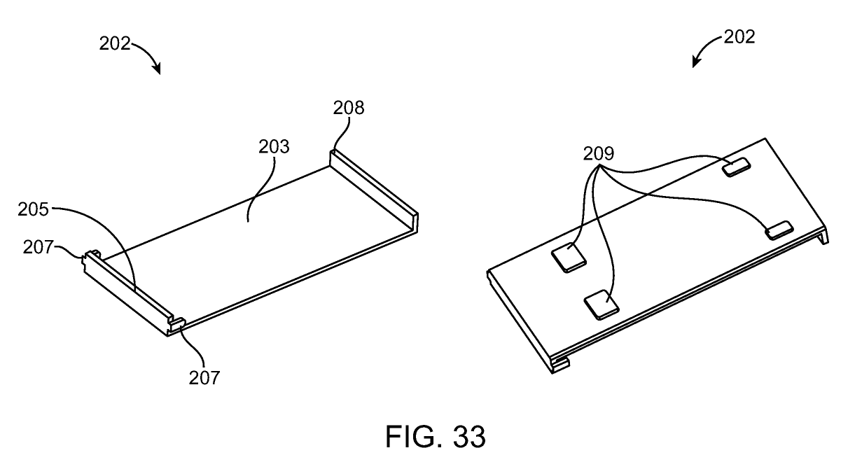

Referring now to FIG. 33, an angular top view and an angular bottom view of the COB support plate 202 is shown to comprise a flat, generally rectangular surface 203, a raised front end 205, a raised back end 208 situated across substantially the entire two widthwise edges thereof, and two front snap coupling tabs 207 situated on the raised front end 205, and four snap coupling back tabs 209 situated on the back side of the flat surface 203.

It should be noted that although in FIG. 33, four back tabs 209 are shown, different number of back tabs 209 may be used in other embodiments of the present invention.

The COB support plate 202 is comprised of a generally rectangular shaped flat surface 203, with the raised front end 205 extending substantially the entire width on one side, and the raised back end 208 extending substantially the entire width on the other side thereof. The four snap coupling back tabs 209 are generally square shaped, and are situated on the center bottom side of the flat surface 203.

The COB support plate 202 is used to hold the COB (shown in FIG. 32) in place, as will be discussed in further detail hereinbelow.

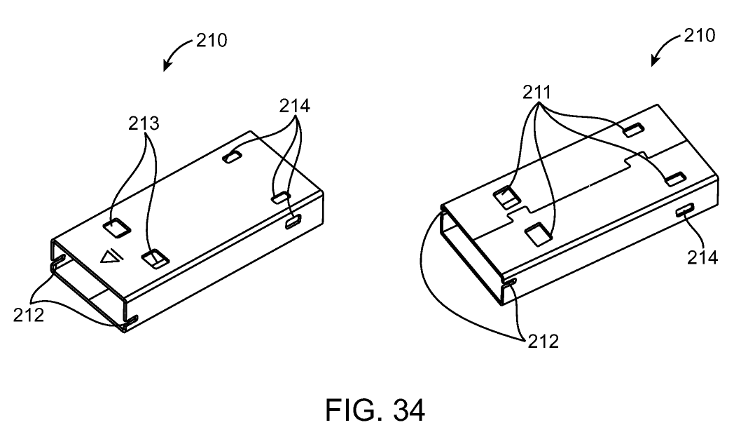

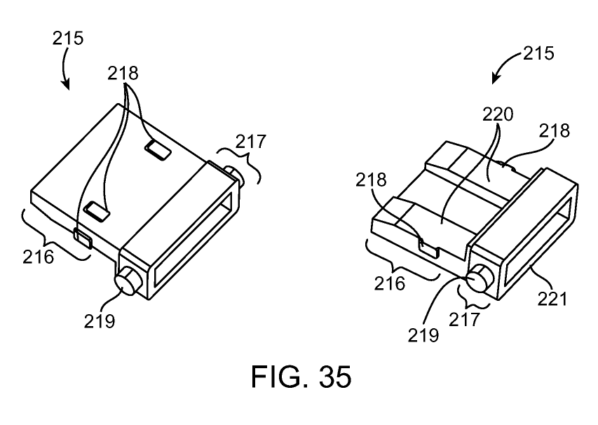

Referring now to FIG. 34, an angular top view and an angular bottom view of the metal case 210 is shown to comprise two snap coupling front slots 212, four snap coupling end slots 214, two USB standard top slots 213, and four snap coupling back slots 211, all in accordance with an embodiment of the present invention.

The metal case 210 is shown to be generally rectangular cube in shape, with two open ends. The snap coupling front slots are shown to be situated on the lower front edge of the two vertical sides of the metal case 210. The two USB standard top slots 213 are situated on the top horizontal side of the metal case 210. Two of the four end slots 214 are shown to be situated generally towards the rear of the top horizontal side. The other two end slots 214 are shown to be situated on the rear of the each of the vertical side. The distance of the four end slots 214 from the rear edge of the metal case 210 is generally shown to be the same. Finally, the four snap coupling back slots 211 are shown to be situated on the bottom surface of the metal case 210.

It should be noted that the USB standard top slots 213 are for the purpose of connecting the portable and retractable flash drive with optional rotary deploying and retracting and fingerprint verification capability 5 via a USB compatible connector. In other embodiments of the present invention, the connector may be configured to other standards, in which case the USB standard top slots 213 would not be present.

The functions of these components will be discussed in further detail hereinbelow.

Referring now to FIG. 35, an angular top view and an angular bottom view of the end plug 215 is shown to include a front area 216, a back area 217, four snap coupling end tabs 218, two buttons 219, two COB end stops 220, and a rear stop 221, in accordance with an embodiment of the present application.

The front area 216 is generally square in shape, with the two snap coupling end tabs 218 situated on the top surface, and one each snap coupling end tabs 218 on the two side surfaces thereof. The bottom surface of the front area 216 is shown to contain thereon two COB end stops 220, shaped generally rectangularly. The back area 217 is shown to be generally rectangular cube in shape, with two outward-pointing buttons 219 on either side thereof.

In one embodiment of the present invention, during manufacturing, the COB 200 (shown in FIG. 32) containing thereon memory circuitry, is placed on top of the COB support plate 202 (shown in FIGS. 32 and 33) with the raised edges 205 and 208 (both shown in FIG. 33) of the COB support plate 202 on either side of the COB 200. The COB support plate 202 is placed inside the bottom of the metal case 210 (shown in FIG. 34). The end plug 215 is inserted into one end of the metal case 210. The four snap coupling end tabs 218 of the end plug snap into the snap coupling end slots 214 (shown in FIG. 34) of the metal case 210, thus holding the end plug 215, firmly in place. The COB end stops 220 of the end plug 215 rest firmly on either side of the LED 201 (shown in FIG. 32) of the COB 200, thus holding the COB 200 and the COB support plate 202 firmly in place.

In the embodiment of the present invention shown in FIGS. 32 through 35, the contact fingers 225 (shown in FIG. 32) of the COB, along with the COB support plate 202, and the metal case 210, jointly form an USB connector that conforms to the USB standard commonly adopted by the industry. In other embodiments of the present invention, other connectors may be formed.

Upon insertion of the end plug 215 into the metal case 210, a connector assembly is manufactured, which is then inserted into the rotary tube 154 (shown in FIG. 32) to one end of which is then rotatably attached the end tube 14 (shown in FIG. 32) and to the other end is attached the end cap 240 (shown in FIG. 32), thus yielding the fully assembled portable and retractable flash drive with optional rotary deploying and retracting and fingerprint verification capability 5.

The manner of attachment of the end tube 14 with the rotary tube 154, the end cap 240, and the connector assembly, and the functionalities thereof are the same as discussed hereinabove. A detailed discussion of the foregoing is avoided due to redundancy.

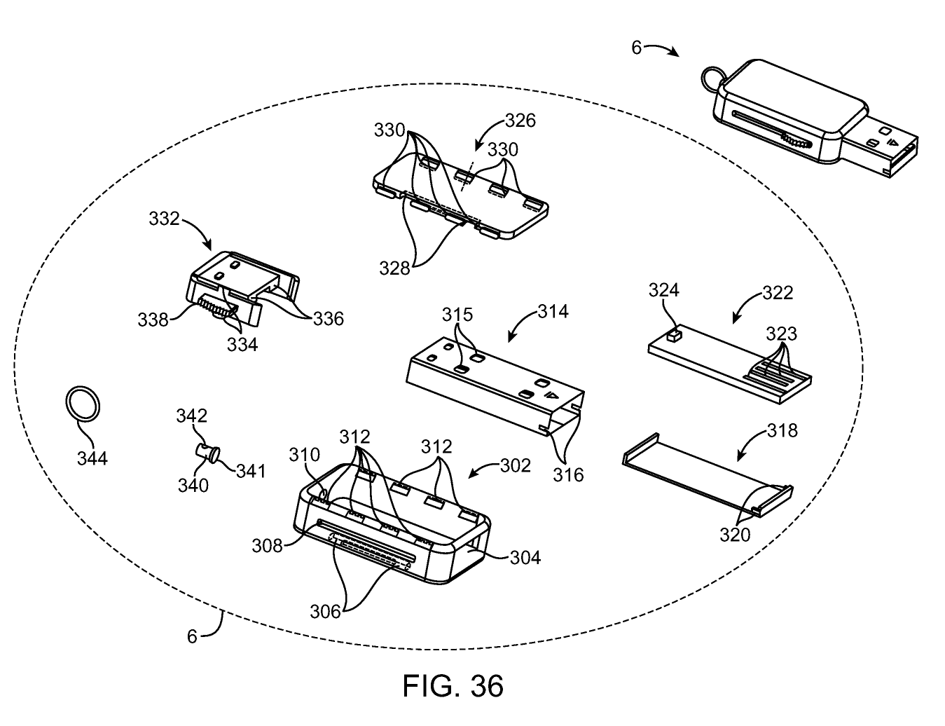

Referring now to FIG. 36, an exploded view and an angular side view of a portable and retractable flash drive with optional rotary deploying and retracting and fingerprint verification capability 6 is shown to comprise a housing chamber 302, a metal case 314, a COB support plate 318, a COB 322, a cover plate 326, an end cap 332, a connector pin 340, and a key ring 344 in accordance with a different embodiment of the present invention.

The housing chamber 302 is shown to include an opening 304, a circular hole 310, a slot 308, a sliding groove 306, and a plurality of snap notches 312.

The housing chamber 302 is shown to be generally a hollow rectangular cube in shape with an open top, and the opening 304 on one end and the circular hole 310 on the opposite end. The housing chamber 302 is shown to further include a slot 308 situated generally in the center length of one side, and a sliding groove 306 on the inside surface of the bottom side and situated close to the slot 308 and generally parallel thereto. The sliding groove 306 is shown to be of generally uniform depth, except for the two ends thereof, which are shown to be slightly deeper than the remainder of the length of the sliding groove 306. Running the lengthwise two edges of the open top side are shown a plurality of snap notches 312. The functionalities of the housing chamber 302 and the components thereof will be explained in further detail hereinbelow.

The metal case 314 is shown to be generally rectangular cube in shape, with two open ends. Two snap coupling front slots 316 are shown to be situated on the lower front edge of the two vertical sides of the metal case 314. Shown formed on top of the metal case 314, on the side opposite from the side where the front slots 316 are situated, are two top-mount slots 315. In other embodiment, different numbers of front slots 316 and top-mount slots 315 may be used. Examples of metals that can be used in forming the metal case 314 include stainless steel 304 or alloy sheet metal with nickel plating. It should be noted that the metals listed herein are only exemplary, and use of other metals is anticipated. The functionalities of the metal case 314 and the components thereof will be explained in further detail hereinbelow.

The COB support plate 318 is shown to be generally flat and rectangular shaped with raised front and back edges extending substantially the entire width on both sides. The COB support plate 318 is shown to further include two front snap coupling tabs 320 situated on one raised end thereof. The functionalities of the COB support plate 318 and the components thereof will be explained in further detail hereinbelow.

The COB 322 is shown to be rectangular in shape, and include a LED 324 and a plurality of contact fingers 323. In one embodiment, the COB 322 contains memory and logic circuitry. Additional functionalities of the COB 322 and the components thereof will be explained in further detail hereinbelow.

The cover plate 326 is shown to be generally rectangular in shape, with a plurality of snap coupling tabs 330 situated on the two lengthwise edges thereof. The cover plate 326 is shown to further include a sliding groove 328 situated parallel to the lengthwise edge of one side. The sliding groove 328 is shown to be of generally uniform depth, except for the two ends thereof, which are shown to be slightly deeper than the remainder of the length of the sliding groove 328. The functionalities of the cover plate 326 and the components thereof will be explained in further detail hereinbelow.

The end cap 332 is shown to be generally rectangular cube in shape, without two sides. Shown formed on one side of the end cap 332 is an outward pointing thumb knob 338, with a plurality of ridges. Shown formed on the bottom and top sides of the same side where the thumb knob 338 are two lock tabs 334, protruding vertically down and up, respectively, from that side. Shown formed on the end of the top side of the end cap 332 are two downward pointing coupling tabs 336. It should be noted that in other embodiments, a different number of coupling 336 tabs may be used. The functionalities of the end cap 332 and the components thereof will be explained in further detail hereinbelow.

The connector pin 340 is shown to be generally a solid cylinder. Attached to one end of the connector pin 340 is shown a ring stop 341, shaped generally circular, and co-axial with the axis of the connector pin 340, with a diameter larger than the diameter of the connector pin 340. The connector pin 340 is also shown to have a center hole 342, situated generally in the middle of the connector pin 340, and running the entire diameter thereof. The functionalities of the connector pin 340 and the components thereof will be explained in further detail hereinbelow.

The key ring 344 is shown to be generally a circular ring. In various embodiments, the key ring 344 may be formed from plastics or metal. In one embodiment, two ends of the material forming the key ring 344 are not fused together. For example, in one embodiment, a small gap exists where the two ends meet. In another embodiment, one end overlaps the other. The functionalities of the key ring 344 and the components thereof will be explained in further detail hereinbelow.

In manufacture, the connector pin 340 is inserted into the circular hole 310 in the housing chamber 302, such that the ring stop 341 of the connector pin 340 is situated inside the housing chamber 302, and the center hole 342 of the connector pin 340 is situated outside the housing chamber 302. Thereafter, the key ring 344 is connected to the connector pin 340, in such a manner as to have a portion of the key ring 344 go through the center hole 342 of the connector pin 340.

Thereafter, the end cap 332 is placed inside the housing chamber 302, in such a manner that the thumb know 338 of the end cap 332 protrudes through the slot 308 of the housing chamber 302, and the bottom locking tab 334 of the end cap 332 rests inside the sliding groove 306 of the housing chamber 302. The end cap 332 can now slide back and forth inside the housing chamber 302. Because the two ends of the sliding groove 306 are slightly deeper than the remainder of the length thereof, the bottom locking tab 334 of the end cap 332 locks when it is situated in either of the ends of the sliding groove 306.

Thereafter, the COB 322 is placed inside the COB support plate 318 in such a manner that the contact fingers 323 of the COB are facing up, and near the side of the COB support plate 318 where the coupling tabs 320 are situated. The dimensions of the COB 322 and COB support plate 318 are such that the COB fits firmly inside the two raised sides of the COB support plate 318.

Thereafter, the COB 322 and the COB support plate 318, joined together, are inserted into the metal case 314, in such a manner that the contact fingers 323 of the COB are facing up and out, and the coupling tabs 320 of the COB support plate 318 snap into the front slots 316 of the metal case 314. The metal case 314, the COB 322, the contact fingers 323, and the COB support plate 318, are structured such that they jointly form a connector. In one embodiment, the connector conforms to the USB standards, widely used in the industry. However, other connector formats may also be used. The COB 322 contains circuitry enabling the storing and retrieval of data files when the connector is attached to a host device.

Thereafter, the metal case 314, containing therein the COB 322 and the COB support plate 318, are inserted through the opening 304 of the housing chamber 302, in such a manner that the contact fingers 323 of the COB are facing up and out. The metal case 314 is then inserted into the end cap 332, until the two coupling tabs 336 of the end cap 332 snap into the two top-mount slots 315 of the metal case 314, causing the end cap 332 and the metal case 314 to be firmly attached. The connector may now be retracted or deployed by sliding the end cap 332 and the metal case 314 back and forth through the opening 304 of the housing chamber 302. When the connector is fully deployed or fully retracted, it locks into position, as discussed hereinabove.

Thereafter, the cover plate 326 is attached to the housing chamber 302, in such a manner that the snap coupling tabs 330 of the cover plate 326 snap into the top notches 312 of the housing chamber 302, and the top lock tab 334 of the end cap 332 rests in the sliding groove 328 of the cover plate 326. It should be noted that in other embodiments, ultrasonic press may be used to attach the cover plate 326 to the housing chamber 302, in addition to, or instead of, the snap coupling tabs 330 of the cover plate 326 and the top notches 312 of the housing chamber 302.

In the embodiment of the present invention shown in FIG. 36, users can deploy or retract the connector by placing forward or backward pressure, respectively on the thumb knob 338, causing the end cap 332, metal case 314, COB 322, and COB support plate 318, which are all joined together, to slide forward and backward, respectively, relative to the housing chamber 302.

When the connector is fully retracted, the end cap 332, metal case 314, COB 322, and COB support plate 318, which are all joined together, are all substantially inside the housing chamber 302, and the top and bottom lock tabs 334 of the end cap 332 are locked in the rear deep portion of the sliding groove 328 of the cover plate 326 and the rear deep portion of the sliding groove 306 of the housing chamber 302, respectively.

What is claimed is:

1. A portable and retractable flash drive with optional rotary deploying and retracting and fingerprint verification capability comprising:
a cylinder assembly including, a connector situated on one end of the cylinder assembly, and a fingerprint sensor, the fingerprint sensor disposed on a surface of the cylinder assembly;
a rotary tube having two ends at least partially enclosing said cylinder assembly for deploying said connector;
an end tube rotatably attached to one of the two ends of said rotary tube, and
an end cap attached to the other of the two ends of said rotary tube,
said rotary tube capable of being rotated relative to said end tube to slide said cylinder assembly back and forth inside the rotary tube to extend and retract said connector,
said connector to couple said portable and retractable flash drive with optional rotary deploying and retracting and fingerprint verification capability to a host device, said fingerprint sensor operative to scan fingerprints of a user of the portable and retractable flash drive with optional rotary deploying and retracting and fingerprint verification capability, and allowing access to data stored on the portable and retractable flash drive with optional rotary deploying and retracting and fingerprint verification capability.

2. A portable and retractable flash drive with optional rotary deploying and retracting and fingerprint verification capability, as recited in claim 1, wherein the connector is configured to conform to universal serial bus (USB) standards.

3. A portable and retractable flash drive with optional rotary deploying and retracting and fingerprint verification capability, as recited in claim 1, wherein
said rotary tube includes an inner surface and an outer surface;
the inner surface of said rotary tube includes spiral slots, and
said cylinder assembly includes buttons,
whereby the rotation of the cylinder assembly relative to said rotary tube is caused by the movement of said buttons in said spiral slots.

4. A portable and retractable flash drive with optional rotary deploying and retracting and fingerprint verification capability, as recited in claim 1, further having the capability to
store the fingerprint of users, and
allow subsequent users access to the data stored on the portable and retractable flash drive with optional rotary deploying and retracting and fingerprint verification capability if the subsequent user's fingerprint matches the stored fingerprint of prior users.

5. A portable and retractable flash drive with optional rotary deploying and retracting and fingerprint verification capability, as recited in claim 4, further including a logo placed on the cylinder assembly, said logo being visible when the connector is retracted, and rotated out of view to expose the fingerprint sensor when the connector is deployed.

6. A portable and retractable flash drive with optional rotary deploying and retracting and fingerprint verification capability, as recited in claim 1, wherein said cylinder assembly includes a printed circuit board (PCB) assembly,
said PCB assembly containing at least one integrated circuit (IC);
said IC, connector, and fingerprint sensor being connected.

7. A portable and retractable flash drive with optional rotary deploying and retracting and fingerprint verification capability, as recited in claim 6, wherein
said cylinder assembly includes a PCB holder and a PCB cover,
said PCB holder and PCB cover together encasing said PCB assembly.

8. A portable and retractable flash drive with optional rotary deploying and retracting and fingerprint verification capability, as recited in claim 6, wherein
the cylinder assembly further includes a metal case and a PCB support tray;
said PCB assembly further includes a plurality of contact fingers;
said PCB support tray being situated inside the metal case, and
said metal case, contact fingers, and the PCB support tray together form said connector.

9. A portable and retractable flash drive with optional rotary deploying and retracting and fingerprint verification capability, as recited in claim 6, wherein
situated on said PCB assembly are at least one memory IC and one controller IC,
said memory IC, controller IC, and connector being connected together.

10. A portable and retractable flash drive with optional rotary deploying and retracting and fingerprint verification capability, as recited in claim 8, wherein the connector is configured to conform to universal serial bus (USB) standards.

11. A portable and retractable flash drive with optional rotary deploying and retracting and fingerprint verification capability, as recited in claim 8, wherein
the rotary tube has an inner surface and an outer surface;
the inner surface of said rotary tube includes spiral slots, and
said cylinder assembly includes buttons,
whereby the rotation of the cylinder assembly relative to said rotary tube is caused by the movement of said buttons in said spiral slots.

12. A portable and retractable flash drive with optional rotary deploying and retracting and fingerprint verification capability comprising:
a connector assembly including a connector, memory circuitry, and controller circuitry;
a rotary tube at least partially enclosing said connector assembly for deploying said connector;
an end tube rotatably attached to said rotary tube, and
an end cap attached to the other end of said rotary tube,
said rotary tube capable of being rotated relative to said end tube to slide said connector assembly back and forth inside the rotary tube to extend and retract said connector,
said connector to couple said portable and retractable flash drive with optional rotary deploying and retracting and fingerprint verification capability to a host device.

13. A portable and retractable flash drive with optional rotary deploying and retracting and fingerprint verification capability, as recited in claim 12, wherein the connector assembly further includes a printed circuit board (PCB), a PCB support tray and a metal case;
said PCB including a plurality of contact fingers;
wherein the PCB's contact fingers are situated inside the PCB support tray,
the PCB support tray is situated inside the metal case,
and the metal case, contact fingers, and PCB support tray jointly form the connector.

14. A portable and retractable flash drive with optional rotary deploying and retracting and fingerprint verification capability, as recited in claim 13, wherein
Said PCB further includes at least one memory integrated circuit (IC) and one controller IC.

15. A portable and retractable flash drive with optional rotary deploying and retracting and fingerprint verification capability, as recited in claim 12, wherein the connector is configured to conform to universal serial bus (USB) standards.

16. A portable and retractable flash drive with optional rotary deploying and retracting and fingerprint verification capability, as recited in claim 12, wherein
the rotary tube has an inner surface and an outer surface;
the inner surface of said rotary tube includes spiral slots;
said connector assembly includes buttons, and
the rotation of the cylinder assembly relative to said rotary tube is caused by the movement of said buttons in said spiral slots.

17. A portable and retractable flash drive with optional rotary deploying and retracting and fingerprint verification capability as recited in claim 12, wherein
the connector assembly further includes a chip on board (COB), a COB support tray, and a metal case;
said COB includes a plurality of contact fingers;
said COB comprising memory and controller circuitry;
said COB being situated inside the COB support tray;
said COB support tray being situated inside the metal case,
wherein
the COB, COB contact fingers, COB support tray, and metal case jointly form the connector.

18. A portable and retractable flash drive with optional rotary deploying and retracting and fingerprint verification capability, as recited in claim 17, wherein the connector is configured to conform to universal serial bus (USB) standards.

19. A portable and retractable flash drive with optional rotary deploying and retracting and fingerprint verification capability, as recited in claim 17, wherein
the rotary tube includes an inner surface and an outer surface;
the inner surface of said rotary tube includes spiral slots;
said connector assembly includes buttons, and
the rotation of the connector assembly relative to said rotary tube is caused by the movement of said buttons in said spiral slots.

20. A portable and retractable flash drive with optional rotary deploying and retracting and fingerprint verification capability comprising:
a connector assembly including a chip on board (COB) including a plurality of contact fingers, a COB support plate, and a metal case;
said COB, contact fingers, COB support plate, and metal case jointly forming a connector;
said connector assembly being situated inside a housing chamber, and
said housing chamber containing an opening;
whereby said connector assembly can slide back and forth in said housing chamber, allowing said connector to extend and retract out of said opening, said connector to couple said portable and retractable flash drive with optional rotary deploying and retracting and fingerprint verification capability to a host device.

21. A portable and retractable flash drive with optional rotary deploying and retracting and fingerprint verification capability, as recited in claim 20, wherein
the COB further includes memory and controller circuitry;
said memory and controller circuitry, metal case, and contact fingers being electrically connected together.

22. A portable and retractable flash drive with optional rotary deploying and retracting and fingerprint verification capability, as recited in claim 20, wherein the connector is configured to conform to universal serial bus (USB) standards.

23. A portable and retractable flash drive with optional rotary deploying and retracting and fingerprint verification capability, as recited in claim 20, wherein
the housing chamber further includes a slot, and
the connector assembly further includes a thumb knob; wherein said thumb knob protrudes from said slot in the housing chamber, allowing a user to extend and retract said connector by moving said thumb knob back and forth.

24. A method of making a portable and retractable flash drive with optional rotary deploying and retracting and fingerprint verification capability comprising:
forming a connector assembly including a memory circuitry, controller circuitry, and a connector;
placing said connector assembly inside a rotary tube including two ends;
rotatably attaching an end tube to one end of said rotary tube, and
attaching an end cap to the other end of said rotary tube.

25. A method of making a portable and retractable flash drive with optional rotary deploying and retracting and fingerprint verification capability as recited in claim 24, wherein the connector assembly is cylindrical in shape, and is formed by:
assembling a printed circuit board (PCB) assembly including a PCB, a memory IC, a controller IC, a fingerprint sensor, and a connector;
placing said PCB assembly on a PCB holder, and
placing a PCB cover on top of the PCB assembly and the PCB holder.

26. A method of making a portable and retractable flash drive with optional rotary deploying and retracting and fingerprint verification capability as recited in claim 25, wherein the connector is configured to conform to universal serial bus (USB) standards.

27. A method of making a portable and retractable flash drive with optional rotary deploying and retracting and fingerprint verification capability as recited in claim 24, wherein the connector assembly is cylindrical in shape, and is manufactured by assembling a printed circuit board (PCB);
placing said PCB assembly on a semi-cylindrical molding structure including a metal case;
placing a PCB support tray between the metal casing and the PCB assembly, and
placing a semi-cylindrical PCB cover on top of the PCB assembly and molding structure.

28. A method of making a portable and retractable flash drive with optional rotary deploying and retracting and fingerprint verification capability as recited in claim 27, wherein
the PCB assembly further contains a memory IC, a controller IC, and a plurality of contact fingers;
said contact fingers, PCB support tray, and metal case together forming the connector.

29. A method of making a portable and retractable flash drive with optional rotary deploying and retracting and fingerprint verification capability as recited in claim 24, wherein the connector assembly is manufactured by:
fabricating a chip on board (COB) containing memory and controller circuitry and a plurality of contact fingers;
placing said COB on a COB support plate, and
placing said COB support plate inside the metal case.

30. A method of making a portable and retractable flash drive with optional rotary deploying and retracting and fingerprint verification capability as recited in claim 29, wherein
the contact fingers of the COB, the COB support plate, and the metal case together form the connector.

31. A method of making a portable and retractable flash drive with optional rotary deploying and retracting and fingerprint verification capability comprising:
forming a connector assembly including a memory circuitry, controller circuitry, and a connector;
placing said connector assembly inside a housing chamber containing an opening, and
placing a cover plate on top of said housing chamber.

32. A method of making a portable and retractable flash drive with optional rotary deploying and retracting and fingerprint verification capability as recited in claim 31, wherein the connector assembly is manufactured by
fabricating a chip on board (COB) containing memory and controller circuitry and a plurality of contact fingers;
placing said COB on a COB support plate, and
placing said COB and COB support plate inside a metal case.

33. A method of making a portable and retractable flash drive with optional rotary deploying and retracting and fingerprint verification capability as recited in claim 32, wherein the COB contact fingers, COB support plate, and metal case jointly form the connector.
